(19) United States
(12) Patent Application Publication
(10) Pub. No.: US 2026/0118637 A1
(43) Pub. Date: Apr. 30, 2026

(54) IMAGING LENS AND IMAGING APPARATUS

(71) Applicant: FUJIFILM Corporation, Tokyo (JP)

(72) Inventor: Taiga NODA, Saitama (JP)

(73) Assignee: FUJIFILM Corporation, Tokyo (JP)

(21) Appl. No.: 19/371,401

(22) Filed: Oct. 28, 2025

(30) Foreign Application Priority Data
Oct. 31, 2024 (JP) 2024-192290

(51) Int. Cl. G02B 13/00

(52) U.S. Cl. CPC G02B 13/0045

(57) ABSTRACT

An imaging lens consists of, in order from an object side toward an image side, a first lens group, a stop, and a second lens group. The second lens group includes two or more lenses that satisfy a conditional expression represented by −15<f/Rf<−0.5, where a focal length of the imaging lens in a state in which an infinite distance object is in focus is denoted by f, and a curvature radius of an object-side surface of a lens included in the imaging lens is denoted by Rf.

### CROSS-REFERENCE TO RELATED APPLICATIONS

This application claims priority from Japanese Patent Application No. 2024-192290, filed on Oct. 31, 2024, the entire disclosure of which is incorporated herein by reference.

### BACKGROUND OF THE INVENTION

### Technical Field

The technology of the present disclosure relates to an imaging lens and an imaging apparatus.

### Related Art

In the related art, an optical system disclosed in JP2016-099436A is known as a lens system that can be used in an imaging apparatus such as a digital camera.

### SUMMARY

There has been a demand for an imaging lens that is compact while maintaining good optical performance. These requirement performance levels are increasing year by year.

The present disclosure provides an imaging lens that is compact while maintaining good optical performance, and an imaging apparatus including the imaging lens.

One aspect of the technology of the present disclosure provides an imaging lens consisting of, in order from an object side toward an image side, a first lens group, a stop, and a second lens group, in which the second lens group includes two or more lenses that satisfy Conditional Expression (1) represented by −15<f/Rf<−0.5 (1), where a focal length of the imaging lens in a state in which an infinite distance object is in focus is denoted by f, and a curvature radius of an object-side surface of a lens included in the imaging lens is denoted by Rf.

It is preferable that, in the imaging lens according to the above-described aspect, in a case in which a focal length of the first lens group is denoted by f1, Conditional Expression (2) represented by 0.1<f/f1<0.9 (2) be satisfied.

It is preferable that, in the imaging lens according to the above-described aspect, in a case in which a focal length of the first lens group is denoted by f1, and a focal length of the second lens group is denoted by f2, Conditional Expression (3) represented by 0.1<f/f2<0.9 (3) be satisfied.

It is preferable that, in the imaging lens according to the above-described aspect, in a case in which a focal length of the first lens group is denoted by f1, and a focal length of the second lens group is denoted by f2, Conditional Expression (4) represented by 0.2<f2/f1<3 (4) be satisfied.

It is preferable that, in the imaging lens according to the above-described aspect, in a case in which a curvature radius of an object-side surface of an extreme object-side lens of the first lens group is denoted by R1f, and a curvature radius of an image-side surface of an extreme object-side lens of the first lens group is denoted by R1r, Conditional Expression (5) represented by −10<(R1r−R1f)/(R1r+R1f)<10 (5) be satisfied.

It is preferable that, in the imaging lens according to the above-described aspect, in a case in which a curvature radius of an object-side surface of an extreme object-side lens of the first lens group is denoted by R1f, Conditional Expression (6) represented by −5<f/R1f<0 (6) be satisfied.

It is preferable that, in the imaging lens according to the above-described aspect, in a case in which a focal length of a lens having strongest positive refractive power among lenses included in the first lens group is denoted by fL1p, Conditional Expression (7) represented by 0.2<f/fL1p<5 (7) be satisfied.

It is preferable that, in the imaging lens according to the above-described aspect, in a case in which a focal length of a lens having strongest negative refractive power among lenses included in the first lens group is denoted by fL1n, Conditional Expression (8) represented by −4<f/fL1n<−0.2 (8) be satisfied.

It is preferable that, in the imaging lens according to the above-described aspect, the second lens group include an air lens formed by two concave lens surfaces facing each other, and in a case in which a paraxial curvature radius of an object-side surface of the air lens of the second lens group is denoted by RAf, and a paraxial curvature radius of an image-side surface of the air lens of the second lens group is denoted by RAr, Conditional Expression (9) represented by −10<(RAr−RAf)/(RAr+RAf)<0 (9) be satisfied.

It is preferable that, in the imaging lens according to the above-described aspect, the first lens group include, successively in order from an extreme object side toward the image side, a first lens having a biconcave shape and a second lens having positive refractive power with a convex surface facing the object side, and in a case in which a spacing on an optical axis between the first lens and the second lens is denoted by d12, and a central thickness of the first lens is denoted by L1th, Conditional Expression (10) represented by 0≤d12/L1th<3 (10) be satisfied.

It is preferable that, in the imaging lens according to the above-described aspect, the second lens group include, on an extreme image side, an extreme image-side lens having positive refractive power with a convex surface facing the image side, and in a case in which a focal length of the extreme image-side lens is denoted by fLe, Conditional Expression (11) represented by 0.2<f/fLe<5 (11) be satisfied.

It is preferable that, in the imaging lens according to the above-described aspect, in a case in which a refractive index of the extreme image-side lens at a d line is denoted by NdLe, Conditional Expression (12) represented by 1.6<NdLe<2.4 (12) be satisfied.

It is preferable that, in the imaging lens according to the above-described aspect, a negative meniscus lens with a convex surface facing the image side be disposed adjacent to the object side of the extreme image-side lens, and in a case in which a spacing on an optical axis between the negative meniscus lens disposed adjacent to the object side of the extreme image-side lens and the extreme image-side lens is denoted by ddLe, Conditional Expression (13) represented by 0≤ddLe/f<0.16 (13) be satisfied.

It is preferable that an image-side lens surface of the extreme image-side lens be an aspherical surface including a region in which positive refractive power is decreased as a distance from the optical axis is increased.

It is preferable that, in the imaging lens according to the above-described aspect, Conditional Expression (14) represented by 0.1<Bf/TL<0.5 (14) be satisfied.

Here, a back focus of the imaging lens in terms of an air-equivalent distance in a state in which the infinite distance object is in focus is denoted by Bf. A sum of a distance on an optical axis from an extreme object-side surface of the first lens group to an extreme image-side surface of the second lens group and the back focus of the imaging lens in terms of the air-equivalent distance in a state in which the infinite distance object is in focus is denoted by TL.

It is preferable that, in the imaging lens according to the above-described aspect, Conditional Expression (15) represented by 1.2<TL/f<3 (15) be satisfied.

Here, a sum of a distance on an optical axis from an extreme object-side surface of the first lens group to an extreme image-side surface of the second lens group and a back focus of the imaging lens in terms of an air-equivalent distance in a state in which the infinite distance object is in focus is TL.

It is preferable that, in the imaging lens according to the above-described aspect, in a case in which a curvature radius of a lens surface adjacent to the object side of the stop is denoted by RSf, and a curvature radius of a lens surface adjacent to the image side of the stop is denoted by RSr, Conditional Expression (16) represented by −10<(RSr-RSf)/(RSr+RSf)<0 (16) be satisfied.

It is preferable that, in the imaging lens according to the above-described aspect, in a case in which a distance on an optical axis from an image plane to a paraxial exit pupil position in a state in which the infinite distance object is in focus is denoted by Dexp, Conditional Expression (17) represented by −3<Dexp/f<−0.7 (17) be satisfied.

Here, a sign of Dexp is defined such that, with the image plane as a reference, a distance toward the object side is negative and a distance toward the image side is positive.

It is preferable that, in the imaging lens according to the above-described aspect, in a case in which an aperture diameter of the stop in an open state is denoted by φap, and an effective diameter of an extreme image-side lens surface of the second lens group is denoted by φend, Conditional Expression (18) represented by 0.3<φap/φend<0.65 (18) be satisfied.

Another aspect of the present disclosure provides an imaging apparatus comprising the imaging lens according to the above-described aspect.

In addition, in the present specification, the expressions “consists of . . . ” and “consisting of . . . ” indicate that a lens substantially without refractive power, an optical element other than a lens, such as a stop, a filter, and a cover glass, mechanism components such as a lens flange, a lens barrel, an imaging element, and a camera shake correction mechanism may be included in addition to the shown constituent elements.

The expression “ . . . group having positive refractive power” in the present specification means that the entire group has positive refractive power. The expression “lens having positive refractive power” and the expression “positive lens” are synonymous. The expressions “lens having negative refractive power” and “negative lens” are synonymous. The expression “ . . . group” in the present specification is not limited to a configuration consisting of a plurality of lenses and may be a configuration consisting of only one lens.

In the present specification, the number of lenses is the number of lenses as components. For example, the number of lenses in a cemented lens in which a plurality of single lenses having different materials are cemented is represented by the number of single lenses constituting this cemented lens. However, the air lenses described later are not included in the number of lenses that are components. In addition, a compound aspherical lens (a lens functioning as one aspherical lens as a whole, in which a lens (for example, a spherical lens) and a film of an aspherical shape formed on the lens are integrated with each other) is not regarded as a cemented lens and is regarded as one lens. Unless otherwise specified, values of a curvature radius, a sign of refractive power, and a surface shape related to a lens including an aspherical surface are taken in a paraxial region. A sign of the curvature radius is defined such that a sign of the curvature radius of a surface having a convex shape facing the object side is positive, and a sign of the curvature radius of a surface having a convex shape facing the image side is negative.

In the present specification, the expression “focal length” used in the conditional expressions means a paraxial focal length. Unless otherwise specified, the expression “distance on the optical axis” used in the conditional expressions means a geometrical distance. Unless otherwise specified, values used in the conditional expressions are values based on a d line in a state in which the infinite distance object is in focus.

The terms “d line”, “C line”, “F line”, and “g line” described in the present specification mean spectral lines. A wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

According to the present disclosure, it is possible to provide the imaging lens that is compact while maintaining good optical performance, and the imaging apparatus including the imaging lens.

### BRIEF DESCRIPTION OF THE DRAWINGS

FIG. 1 is a cross-sectional view showing a configuration of an imaging lens according to one embodiment, which corresponds to an imaging lens according to Example 1.

FIG. 2 is a cross-sectional view showing a configuration and a luminous flux in each state of the imaging lens in FIG. 1.

FIG. 3 is a diagram showing symbols of a conditional expression.

FIG. 4 is a diagram showing an effective diameter.

FIG. 5 is each aberration diagram of the imaging lens according to Example 1.

FIG. 6 is a cross-sectional view showing a configuration of an imaging lens according to Example 2.

FIG. 7 is each aberration diagram of the imaging lens according to Example 2.

FIG. 8 is a cross-sectional view showing a configuration of an imaging lens according to Example 3.

FIG. 9 is each aberration diagram of the imaging lens according to Example 3.

FIG. 10 is a cross-sectional view showing a configuration of an imaging lens according to Example 4.

FIG. 11 is each aberration diagram of the imaging lens according to Example 4.

FIG. 12 is a cross-sectional view showing a configuration of an imaging lens according to Example 5.

FIG. 13 is each aberration diagram of the imaging lens according to Example 5.

FIG. 14 is a cross-sectional view showing a configuration of an imaging lens according to Example 6.

FIG. 15 is each aberration diagram of the imaging lens according to Example 6.

FIG. 16 is a cross-sectional view showing a configuration of an imaging lens according to Example 7.

FIG. 17 is each aberration diagram of the imaging lens according to Example 7.

FIG. 18 is a cross-sectional view showing a configuration of an imaging lens according to Example 8.

FIG. 19 is each aberration diagram of the imaging lens according to Example 8.

FIG. 20 is a cross-sectional view showing a configuration of an imaging lens according to Example 9.

FIG. 21 is each aberration diagram of the imaging lens according to Example 9.

FIG. 22 is a perspective view of a front surface side of an imaging apparatus according to one embodiment.

FIG. 23 is a perspective view of a rear surface side of the imaging apparatus according to the embodiment.

### DETAILED DESCRIPTION

Hereinafter, embodiments of the present disclosure will be described with reference to the drawings.

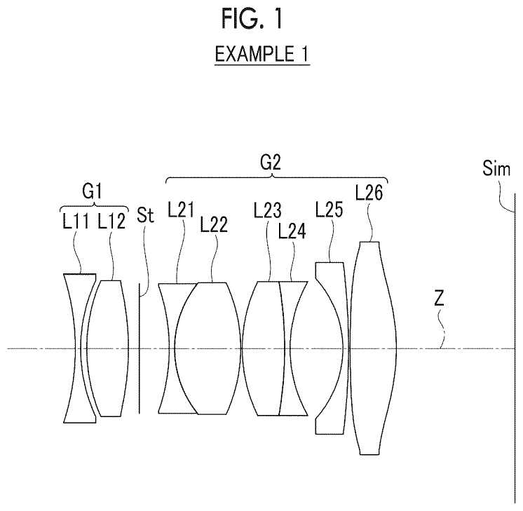

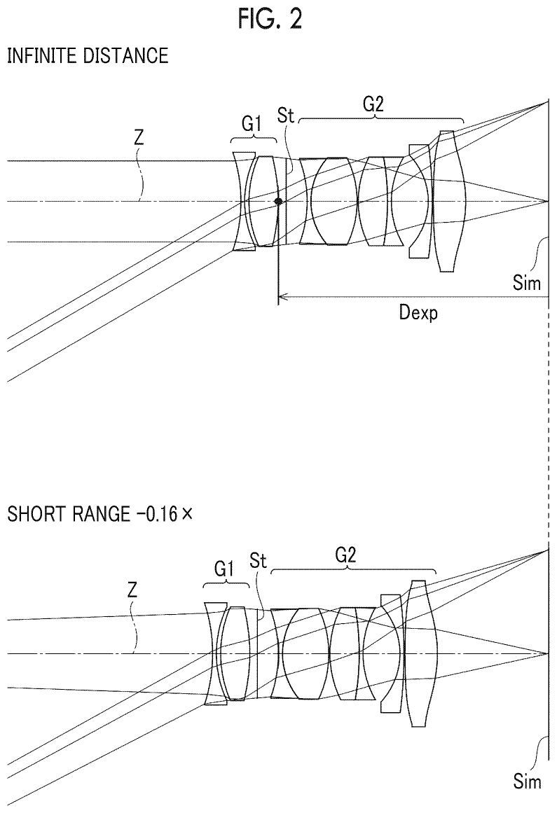

FIG. 1 shows a cross-sectional view of a configuration of an imaging lens according to the embodiment of the present disclosure. FIG. 2 is a cross-sectional view of a configuration and a luminous flux of the imaging lens in FIG. 1. In FIG. 2, an upper part labeled “infinite distance” shows a state in which the infinite distance object is in focus, and a lower part labeled “short range −0.16×” shows a state in which the short range object of which the imaging magnification is −0.16× is in focus. FIG. 2 shows, as luminous fluxes, an on-axis luminous flux and a luminous flux having a maximum half angle of view in a state in which the infinite distance object is in focus, and an on-axis luminous flux and a luminous flux having a maximum half angle of view in a state in which the short range object is in focus. In FIGS. 1 and 2, a left side is an object side, and a right side is an image side. The examples shown in FIGS. 1 and 2 correspond to an imaging lens according to Example 1 described later. Hereinafter, the description will be made mainly with reference to FIG. 1.

The imaging lens according to the present disclosure is a fixed focal point optical system and consists of, in order from the object side toward the image side along an optical axis Z, a first lens group G1, an aperture stop St, and a second lens group G2. By using the fixed focal point optical system, the optical system can be configured to be compact.

As an example, each group of the imaging lens in FIG. 1 is formed as follows. The first lens group G1 consists of, in order from the object side toward the image side, two lenses, that is, lenses L11 and L12. The second lens group G2 consists of, in order from the object side toward the image side, six lenses, that is, lenses L21 to L26. The aperture stop St in FIG. 1 does not indicate a size or a shape and indicates a position in an optical axis direction. This showing method of the aperture stop St also applies to other cross-sectional views in the same manner.

In the imaging lens according to the present disclosure, the L1 lens having negative refractive power may be disposed on the extreme object side of the first lens group G1. In such a case, the angle of view can be widened. In the example shown in FIG. 1, the lens L11 corresponds to the L1 lens.

The L1r lens having positive refractive power may be disposed on the extreme image side of the first lens group G1. In such a case, it is advantageous for the reduction in size. In the example shown in FIG. 1, the lens L12 corresponds to the L1r lens.

The first lens group G1 may include a negative lens and a positive lens successively in order from the object side toward the image side. In such a case, it is advantageous for the various aberration correction.

It is preferable that the first lens group G1 include one or more lenses of which at least one of an object-side lens surface or an image-side lens surface is an aspherical surface. In such a case, it is advantageous for the various aberration correction.

The first lens group G1 may consist of two or three lenses. In such a case, it is easy to reduce the outer diameter of the lens on the object side with respect to the aperture stop St, and it is advantageous for achieving reduction in size.

It is preferable that the second lens group G2 include an air lens formed of two concave lens surfaces facing toward each other. In the present specification, the air spacing between two lens surfaces facing toward each other is regarded as a lens having a refractive index of 1, and this air spacing is referred to as an air lens. In a case in which the biconvex air lens is present in the second lens group G2, it is easy to suppress the Petzval sum of the entire optical system. In the example shown in FIG. 1, a biconvex air lens is formed by the image-side surface of the lens L24 and the object-side surface of the lens L25.

It is preferable that the second lens group G2 include, on the extreme image side, an extreme image-side lens having positive refractive power with a convex surface facing the image side. In such a case, it is easy to reduce an incidence angle of a principal ray on an image plane Sim.

It is preferable that an image-side lens surface of the extreme image-side lens be an aspherical surface including a region in which positive refractive power is decreased as a distance from the optical axis Z is increased. In such a case, it is easy to correct on-axis spherical aberration and off-axis astigmatism in a well-balanced manner.

It is preferable that a negative meniscus lens with a convex surface facing the image side is disposed adjacent to the object side of the extreme image-side lens. In such a case, it is advantageous for the lateral chromatic aberration correction.

It is preferable that the second lens group G2 include a positive lens of which an Abbe number based on a d line is greater than 70. In such a case, it is advantageous for the chromatic aberration correction.

It is preferable that the second lens group G2 include a cemented lens in which a biconcave lens and a biconvex lens are cemented in order from the object side, and it is more preferable that the d line-based Abbe number of the biconvex lens in the cemented lens be greater than 70. In such a case, it is further advantageous for correcting chromatic aberration.

The second lens group G2 may include two sets of cemented lenses in which a negative lens and a positive lens are cemented. In such a case, it is further advantageous for correcting chromatic aberration. In such a case, for example, a cemented lens in which a negative lens and a positive lens are cemented in order from the object side, and a cemented lens in which a positive lens and a negative lens are cemented in order from the object side may be disposed adjacent to each other in order from the object side to the image side. In such a case, it is advantageous for achieving both the chromatic aberration correction and the reduction in size.

It is preferable that the imaging lens according to the present disclosure include four or more positive lenses and four or more negative lenses. In such a case, it is advantageous for the various aberration correction.

The number of lenses included in the imaging lens according to the present disclosure may be nine or less. In such a case, it is easy to reduce the size of the optical system.

The imaging lens according to the present disclosure may be configured such that focusing is performed by integrally moving the first lens group G1, the aperture stop St, and the second lens group G2. In addition, in the present specification, the expression “move integrally” means moving by the same amount in the same direction at the same time. By adopting the configuration in which the entire imaging lens moves integrally during focusing, it is advantageous for suppressing fluctuation in aberrations during focusing.

Next, preferred configurations of the imaging lens according to the present disclosure related to conditional expressions will be described. In the following description of the conditional expressions, in order to avoid redundancy, the same symbol will be used for the same definition, and repetitive descriptions are omitted. Hereinafter, the “imaging lens according to the present disclosure” will be simply referred to as the “imaging lens” in order to avoid redundancy.

It is preferable that the second lens group G2 include two or more lenses that satisfy Conditional Expression (1). However, the above-described “two or more lenses that satisfy Conditional Expression (1)” shall be counted without including the air lens. Here, a focal length of the imaging lens in a state in which the infinite distance object is in focus is denoted by f. A curvature radius of the object-side surface of the lens included in the imaging lens is denoted by Rf. In the present specification, a sign of the curvature radius of a surface convex toward the object side is positive, and a sign of the curvature radius of a surface convex toward the image side is negative. Therefore, the object-side surface of the lens that satisfies Conditional Expression (1) is a concave surface. In a configuration consisting of the first lens group G1, the aperture stop St, and the second lens group G2 in order from the object side toward the image side, by disposing two or more lenses with a concave surface facing the object side, in the second lens group G2, off-axis rays can be deflected at a large angle, so that it is easy to reduce the total optical length. Further, by preventing the corresponding value of Conditional Expression (1) from becoming equal to or less than the lower limit value, off-axis rays can be deflected at a sufficiently large angle. By preventing the corresponding value of Conditional Expression (1) from becoming equal to or greater than the upper limit value, astigmatism correction is facilitated.

$$- 15 < f / Rf < - 0.5 \qquad ( 1 )$$

In order to obtain more favorable characteristics, the lower limit value of Conditional Expression (1) is more preferably −13, still more preferably −11, still more preferably −9, still more preferably −7, still more preferably −6, still more preferably −5, still more preferably −4.5, and still more preferably −4. In order to obtain more favorable characteristics, the upper limit value of Conditional Expression (1) is more preferably −0.8, still more preferably −1, still more preferably −1.2, still more preferably −1.22, still more preferably −1.24, still more preferably −1.26, still more preferably −1.28, and still more preferably −1.3.

In a case in which a focal length of the first lens group G1 is denoted by f1, it is preferable that the imaging lens satisfy Conditional Expression (2). By preventing the corresponding value of Conditional Expression (2) from becoming equal to or less than the lower limit value, the focal length of the first lens group G1 does not become excessively long, making it possible to suppress an increase in the overall optical length, which is advantageous for compactness. By preventing the corresponding value of Conditional Expression (2) from becoming equal to or greater than the upper limit value, correction of spherical aberration and distortion generated in the first lens group G1 is facilitated.

$$0.1 < f / f 1 < 0.9 \qquad ( 2 )$$

In order to obtain more favorable characteristics, the lower limit value of Conditional Expression (2) is more preferably 0.2, still more preferably 0.25, still more preferably 0.3, still more preferably 0.34, still more preferably 0.37, still more preferably 0.4, still more preferably 0.43, and still more preferably 0.45. In order to obtain more favorable characteristics, the upper limit value of Conditional Expression (2) is more preferably 0.8, still more preferably 0.77, still more preferably 0.74, still more preferably 0.71, still more preferably 0.69, still more preferably 0.67, still more preferably 0.65, and still more preferably 0.63.

In a case in which a focal length of the second lens group G2 is denoted by f2, it is preferable that the imaging lens satisfy Conditional Expression (3). By preventing the corresponding value of Conditional Expression (3) from becoming equal to or less than the lower limit value, an increase in the overall optical length can be suppressed, which is advantageous for compactness. By preventing the corresponding value of Conditional Expression (3) from becoming equal to or greater than the upper limit value, aberration correction, particularly correction of field curvature and distortion, is facilitated.

$$0.1 < f / f 2 < 0.9 \qquad ( 3 )$$

In order to obtain more favorable characteristics, the lower limit value of Conditional Expression (3) is more preferably 0.2, still more preferably 0.25, still more preferably 0.3, still more preferably 0.34, still more preferably 0.37, still more preferably 0.4, still more preferably 0.43, and still more preferably 0.45. In order to obtain more favorable characteristics, the upper limit value of Conditional Expression (3) is more preferably 0.8, still more preferably 0.77, still more preferably 0.74, still more preferably 0.71, still more preferably 0.69, still more preferably 0.67, still more preferably 0.65, and still more preferably 0.63.

It is preferable that the imaging lens satisfy Conditional Expression (4). By preventing the corresponding value of Conditional Expression (4) from becoming equal to or less than the lower limit value, various aberrations, such as spherical aberration, can be suppressed. By preventing the corresponding value of Conditional Expression (4) from becoming equal to or greater than the upper limit value, a wide angle of view can be advantageously obtained.

$$0.2 < f 2 / f 1 < 3 \qquad ( 4 )$$

In order to obtain more favorable characteristics, the lower limit value of Conditional Expression (4) is preferably 0.3, more preferably 0.35, still more preferably 0.4, still more preferably 0.45, still more preferably 0.5, still more preferably 0.55, still more preferably 0.6, and still more preferably 0.65. In order to obtain more favorable characteristics, the upper limit value of Conditional Expression (4) is more preferably 2.5, still more preferably 2, still more preferably 1.6, still more preferably 1.45, still more preferably 1.35, still more preferably 1.28, still more preferably 1.21, and still more preferably 1.15.

It is preferable that the imaging lens satisfy Conditional Expression (5). Here, the curvature radius of the object-side surface of the extreme object-side lens of the first lens group G1 is denoted by R1f. The curvature radius of the image-side surface of the extreme object-side lens of the first lens group G1 is denoted by R1r. By preventing the corresponding value of Conditional Expression (5) from becoming equal to or less than the lower limit value, good correction of astigmatism is facilitated. By preventing the corresponding value of Conditional Expression (5) from becoming equal to or greater than the upper limit value, good correction of spherical aberration is facilitated. Furthermore, by preventing the corresponding value of Conditional Expression (5) from becoming equal to or greater than the upper limit value, the refractive power of the extreme object-side lens of the first lens group G1 is not excessively decreased, thereby making it easier to achieve a wide angle of view.

$$- 10 < ( R 1 r - R 1 f ) / ( R 1 r + R 1 f ) < 10 \qquad ( 5 )$$

In order to obtain more favorable characteristics, the lower limit value of Conditional Expression (5) is more preferably −8, still more preferably −6, still more preferably −4, still more preferably −3, still more preferably −2, still more preferably −1.7, still more preferably −1.5, and still more preferably −1.2. In order to obtain more favorable characteristics, the upper limit value of Conditional Expression (5) is more preferably 8, still more preferably 6, still more preferably 3, still more preferably 1, still more preferably 0.2, still more preferably −0.1, still more preferably −0.3, and still more preferably −0.5.

It is preferable that the imaging lens satisfy Conditional Expression (6). By setting the surface shape of the extreme object-side lens of the first lens group G1 so as to satisfy Conditional Expression (6), it is easy to suppress distortion.

$$- 5 < f / R 1 f < 0 \qquad ( 6 )$$

In order to obtain more favorable characteristics, the lower limit value of Conditional Expression (6) is more preferably −4, still more preferably −3, still more preferably −2.5, still more preferably −2, still more preferably −1.6, still more preferably −1.4, still more preferably −1.2, and still more preferably −1.1. In order to obtain more favorable characteristics, the upper limit value of Conditional Expression (6) is more preferably −0.1, still more preferably −0.2, still more preferably −0.3, still more preferably −0.4, still more preferably −0.5, still more preferably −0.6, still more preferably −0.7, and still more preferably −0.8.

It is preferable that the imaging lens satisfy Conditional Expression (7). Here, the focal length of the lens having the strongest positive refractive power among the lenses included in the first lens group G1 is denoted by fL1p. By preventing the corresponding value of Conditional Expression (7) from becoming equal to or less than the lower limit value, it is advantageous for shortening the overall optical length and also facilitates securing peripheral illumination. By preventing the corresponding value of Conditional Expression (7) from becoming equal to or greater than the upper limit value, the refractive power of the lens having the strongest positive refractive power among the lenses included in the first lens group G1 is not excessively increased, which is advantageous for correcting distortion and field curvature.

$$0.2 < f / fL 1 p < 5 \qquad ( 7 )$$

In order to obtain more favorable characteristics, the lower limit value of Conditional Expression (7) is preferably 0.4, more preferably 0.6, still more preferably 0.7, still more preferably 0.8, still more preferably 0.9, still more preferably 1, still more preferably 1.1, and still more preferably 1.2. In order to obtain more favorable characteristics, the upper limit value of Conditional Expression (7) is more preferably 4, still more preferably 3.2, still more preferably 2.5, still more preferably 2, still more preferably 1.8, still more preferably 1.7, still more preferably 1.6, and still more preferably 1.5.

It is preferable that the imaging lens satisfy Conditional Expression (8). Here, the focal length of the lens having the strongest negative refractive power among the lenses included in the first lens group G1 is denoted by fL1n. By preventing the corresponding value of Conditional Expression (8) from becoming equal to or less than the lower limit value, distortion correction is facilitated. By preventing the corresponding value of Conditional Expression (8) from becoming equal to or greater than the upper limit value, field curvature correction is facilitated.

$$- 4 < f / fL 1 n < - 0.2 \qquad ( 8 )$$

In order to obtain more favorable characteristics, a lower limit value of Conditional Expression (8) is more preferably −2, still more preferably −1.8, still more preferably −1.6, still more preferably −1.4, still more preferably −1.3, still more preferably −1.2, and still more preferably −1.1. In order to obtain more favorable characteristics, an upper limit value of Conditional Expression (8) is more preferably −0.4, still more preferably −0.5, still more preferably −0.6, still more preferably −0.65, still more preferably −0.7, still more preferably −0.75, and still more preferably −0.8.

In a configuration in which the second lens group G2 includes an air lens formed by two concave lens surfaces facing each other, it is preferable that the imaging lens satisfy Conditional Expression (9). Here, the paraxial curvature radius of the object-side surface of the air lens of the second lens group G2 is denoted by RAf. The paraxial curvature radius of the image-side surface of the air lens of the second lens group G2 is denoted by RAr. By satisfying Conditional Expression (9), it is possible to prevent the refractive power of one surface of the object-side surface and the image-side surface of the air lens from being excessively increased or excessively decreased with respect to the refractive power of the other surface. Accordingly, spherical aberration and astigmatism can be suitably corrected, and the Petzval sum of the entire lens system can be suppressed.

$$- 10 < ( RAr - RAf ) / ( RAr + RAf ) < 0 \qquad ( 9 )$$

In order to obtain more favorable characteristics, the lower limit value of Conditional Expression (9) is more preferably −8, still more preferably −7, still more preferably −6, still more preferably −5.5, still more preferably −5, still more preferably −4.5, still more preferably −4, and still more preferably −3.5. In order to obtain more favorable characteristics, the upper limit value of Conditional Expression (9) is more preferably −0.5, still more preferably −1, still more preferably −1.4, still more preferably −1.7, still more preferably −2, still more preferably −2.3, still more preferably −2.6, and still more preferably −2.9.

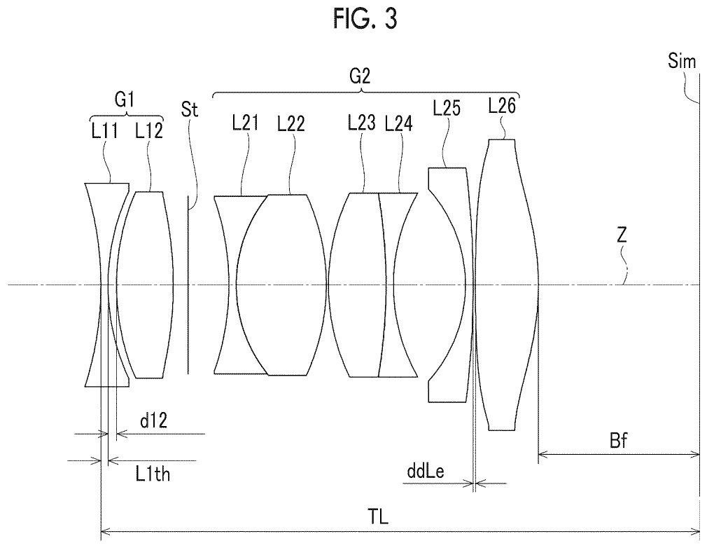

In a configuration in which the first lens group G1 includes a biconcave first lens and a second lens having positive refractive power with a convex surface facing the object side, successively in order from the extreme object side toward the image side, it is preferable that the imaging lens satisfy Conditional Expression (10). Here, the spacing on the optical axis between the first lens and the second lens is denoted by d12. The central thickness of the first lens is denoted by L1th. FIG. 3 shows a configuration diagram of the imaging lens of FIG. 1, and shows the above-described spacing d12 and the central thickness LIth as an example. By preventing the corresponding value of Conditional Expression (10) from becoming equal to or greater than the upper limit value, the focal length of the first lens group G1 does not become excessively long, allowing an increase in the overall optical length to be avoided.

$$0 \leq d 12 / L 1 th < 3 \qquad ( 10 )$$

In order to obtain more favorable characteristics, an upper limit value of Conditional Expression (10) is more preferably 2, still more preferably 1.6, still more preferably 1.2, still more preferably 0.9, still more preferably 0.72, and still more preferably 0.55.

In a configuration in which the second lens group G2 includes, on the extreme image side, a most image-side lens having positive refractive power with a convex surface facing the image side, it is preferable that the imaging lens satisfy Conditional Expression (11). Here, the focal length of the extreme image-side lens is denoted by fLe. By preventing the corresponding value of Conditional Expression (11) from becoming equal to or less than the lower limit value, reducing the angle of incidence of the principal ray onto the image plane Sim is facilitated. By preventing the corresponding value of Conditional Expression (11) from becoming equal to or greater than the upper limit value, the occurrence of distortion can be suppressed.

$$0.2 < f / fLe < 5 \qquad ( 11 )$$

In order to obtain more favorable characteristics, a lower limit value of Conditional Expression (11) is more preferably 0.6, still more preferably 1, still more preferably 1.1, still more preferably 1.2, still more preferably 1.25, and still more preferably 1.3. In order to obtain more favorable characteristics, an upper limit value of Conditional Expression (11) is more preferably 2, still more preferably 1.8, still more preferably 1.7, still more preferably 1.6, still more preferably 1.55, and still more preferably 1.5.

In a case in which the refractive index of the extreme image-side lens at the d line is denoted by NdLe, it is preferable that the imaging lens satisfy Conditional Expression (12). By preventing the corresponding value of Conditional Expression (12) from becoming equal to or less than the lower limit value, the positive refractive power of the extreme image-side lens is not excessively decreased, thereby making it easier to reduce the angle of incidence of the principal ray onto the image plane Sim. By preventing the corresponding value of Conditional Expression (12) from becoming equal to or greater than the upper limit value, the positive refractive power of the extreme image-side lens is not excessively increased, thereby allowing the occurrence of distortion to be suppressed.

$$1.6 < NdLe < 2.4 \qquad ( 12 )$$

In order to obtain more favorable characteristics, a lower limit value of Conditional Expression (12) is more preferably 1.65, still more preferably 1.7, still more preferably 1.72, still more preferably 1.74, still more preferably 1.76, and still more preferably 1.78. In order to obtain more favorable characteristics, an upper limit value of Conditional Expression (12) is more preferably 2.2, still more preferably 1.98, still more preferably 1.9, still more preferably 1.88, still more preferably 1.87, and still more preferably 1.86.

In a configuration in which a negative meniscus lens with a convex surface facing the image side is disposed adjacent to the object side of the extreme image-side lens, it is preferable that the imaging lens satisfy Conditional Expression (13). Here, a spacing on the optical axis between the negative meniscus lens disposed adjacent to the object side of the extreme image-side lens and the extreme image-side lens is denoted by ddLe. For example, FIG. 3 shows the spacing ddLe. By preventing the corresponding value of Conditional Expression (13) from becoming equal to or greater than the upper limit value, the length of the second lens group G2 in the optical axis direction does not become excessively long, allowing an increase in the overall optical length to be avoided.

$$0 \leq ddLe / f < 0 \text{.16} \qquad ( 13 )$$

In order to obtain more favorable characteristics, the upper limit value of Conditional Expression (13) is more preferably 0.12, still more preferably 0.08, still more preferably 0.04, still more preferably 0.02, and still more preferably 0.01.

It is preferable that the imaging lens satisfy Conditional Expression (14). Here, a back focus of the imaging lens in terms of an air-equivalent distance in a state in which the infinite distance object is in focus is denoted by Bf. A sum of a distance on the optical axis from the extreme object-side surface of the first lens group G1 to the extreme image-side surface of the second lens group G2 and the back focus of the imaging lens in terms of the air-equivalent distance in a state in which the infinite distance object is in focus is denoted by TL. TL denotes the total length in a state in which the infinite distance object is in focus. For example, FIG. 3 shows the back focus Bf and the total length TL. By preventing the corresponding value of Conditional Expression (14) from becoming equal to or less than the lower limit value, reducing the angle of incidence of the principal ray onto the image plane Sim is facilitated. By preventing the corresponding value of Conditional Expression (14) from becoming equal to or greater than the upper limit value, correction of various aberrations, such as spherical aberration and field curvature, is facilitated while reducing the size of the imaging lens.

$$0.1 < Bf / TL < 0.5 \qquad ( 14 )$$

In order to obtain more favorable characteristics, the lower limit value of Conditional Expression (14) is more preferably 0.2 and more preferably 0.25. In order to obtain more favorable characteristics, the upper limit value of Conditional Expression (14) is more preferably 0.4 and still more preferably 0.35.

It is preferable that the imaging lens satisfy Conditional Expression (15). By preventing the corresponding value of Conditional Expression (15) from becoming equal to or less than the lower limit value, suppression of various aberrations is facilitated. By preventing the corresponding value of Conditional Expression (15) from becoming equal to or greater than the upper limit value, it is advantageous for reducing overall size of the imaging lens.

$$1.2 < TL / f < 3 \qquad ( 15 )$$

In order to obtain more favorable characteristics, a lower limit value of Conditional Expression (15) is more preferably 1.3, still more preferably 1.4, still more preferably 1.45, and still more preferably 1.5. In order to obtain more favorable characteristics, the upper limit value of Conditional Expression (15) is more preferably 2, still more preferably 1.75, still more preferably 1.7, and still more preferably 1.65.

It is preferable that the imaging lens satisfy Conditional Expression (16). Here, the curvature radius of the lens surface adjacent to the object side of the aperture stop St is denoted by RSf. The curvature radius of the lens surface adjacent to the image side of the aperture stop St is denoted by RSr. By preventing the corresponding value of Conditional Expression (16) from becoming equal to or less than the lower limit value, spherical aberration correction is facilitated. By preventing the corresponding value of Conditional Expression (16) from becoming equal to or greater than the upper limit value, overcorrection of spherical aberration can be suppressed.

$$- 10 < ( RSr - RSf ) / ( RSr + RSf ) < 0 \qquad ( 16 )$$

In order to obtain more favorable characteristics, the lower limit value of Conditional Expression (16) is more preferably −8, still more preferably −6, still more preferably −4, still more preferably −2, still more preferably −1.5, still more preferably −1.2, still more preferably −1, and still more preferably −0.8. In order to obtain more favorable characteristics, the upper limit value of Conditional Expression (16) is more preferably −0.1, still more preferably −0.2, still more preferably −0.25, still more preferably −0.3, still more preferably −0.35, still more preferably −0.4, still more preferably −0.45, and still more preferably −0.5.

It is preferable that the imaging lens satisfy Conditional Expression (17). Here, a distance on the optical axis from the image plane Sim to the paraxial exit pupil position in a state in which the infinite distance object is in focus is denoted by Dexp. Here, a sign of Dexp is defined such that, with the image plane Sim as a reference, a distance toward the object side is negative and a distance toward the image side is positive. In a case in which an optical member having no refractive power is disposed between the image plane Sim and the paraxial exit pupil position, Dexp is calculated using the air-equivalent distance for the optical member. For example, the upper part of FIG. 2 shows the distance Dexp. By preventing the corresponding value of Conditional Expression (17) from becoming equal to or less than the lower limit value, the positive refractive power of the second lens group G2 is not excessively decreased, thereby facilitating correction of field curvature. By preventing the corresponding value of Conditional Expression (17) from becoming equal to or greater than the upper limit value, reducing the angle of incidence of the principal ray onto the image plane Sim is facilitated.

$$- 3 < Dexp / f < - 0.7 \qquad ( 17 )$$

In order to obtain more favorable characteristics, the lower limit value of Conditional Expression (17) is more preferably −2.5, still more preferably −2, still more preferably −1.8, and still more preferably −1.6. In order to obtain more favorable characteristics, the upper limit value of Conditional Expression (17) is more preferably −1, still more preferably −1.1, still more preferably −1.2, and still more preferably −1.3.

It is preferable that the imaging lens satisfy Conditional Expression (18). Here, the aperture diameter of the aperture stop St in an open state is denoted by φap. The effective diameter of the extreme image-side lens surface of the second lens group G2 is denoted by φend. By preventing the corresponding value of Conditional Expression (18) from becoming equal to or less than the lower limit value, the aperture diameter of the aperture stop St can be increased, thereby securing brightness. By preventing the corresponding value of Conditional Expression (18) from becoming equal to or greater than the upper limit value, the diameters of the first lens group G1 and the aperture stop St do not become excessively large, which is advantageous for reducing the overall weight of the imaging lens.

$$0.3 < φ ap / φ end < 0.65 \qquad ( 18 )$$

In order to obtain more favorable characteristics, the lower limit value of Conditional Expression (18) is more preferably 0.32, still more preferably 0.33, still more preferably 0.34, and still more preferably 0.35. In order to obtain more favorable characteristics, an upper limit value of Conditional Expression (18) is more preferably 0.55, still more preferably 0.49, still more preferably 0.45, and still more preferably 0.42.

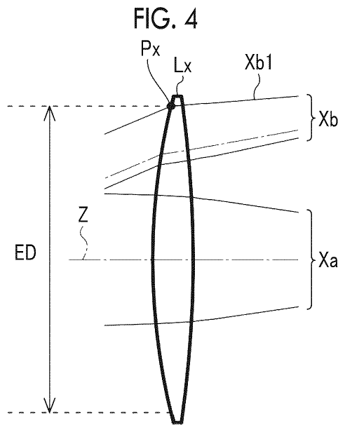

Here, the “effective diameter” will be described with reference to FIG. 4. FIG. 4 is a diagram for description, and shows a configuration in a cross section including the optical axis Z. In FIG. 4, a left side is the object side, and a right side is the image side. In FIG. 4, an on-axis luminous flux Xa and an off-axis luminous flux Xb that pass through a lens Lx are shown. In the example shown in FIG. 4, a ray Xb1 that is an upper ray in the off-axis luminous flux Xb is a ray passing through an outermost side. The expression “outer side” herein means an outer side in a diameter direction centered on the optical axis Z, that is, a side away from the optical axis Z. In the present specification, the effective diameter ED is twice a distance from the position Px of the intersection between the ray passing through the outermost side and the lens surface to the optical axis Z. While the upper ray of the off-axis luminous flux Xb is the ray passing through the outermost side in the example shown in FIG. 4, which ray is the ray passing through the outermost side varies depending on the optical system.

In a configuration in which the L1 lens having negative refractive power is disposed on the extreme object side of the first lens group G1, it is preferable that the imaging lens satisfy Conditional Expression (19). Here, the refractive index of the L1 lens at the d line is denoted by Nd1. By preventing the corresponding value of Conditional Expression (19) from becoming equal to or less than the lower limit value, even in a case in which the L1 lens is given the required negative refractive power, it is possible to suppress the absolute value of the curvature radius of the L1 lens from becoming excessively small, thereby facilitating correction of field curvature. By preventing the corresponding value of Conditional Expression (19) from becoming equal to or greater than the upper limit value, it is possible to select a low-dispersion material for the L1 lens, which is advantageous for chromatic aberration correction.

$$5 < Nd 1 < 24 \qquad ( 19 )$$

In order to obtain more favorable characteristics, a lower limit value of Conditional Expression (19) is more preferably 1.53, still more preferably 1.55, still more preferably 1.57, still more preferably 1.59, still more preferably 1.6, still more preferably 1.61, and still more preferably 1.62. In order to obtain more favorable characteristics, an upper limit value of Conditional Expression (19) is more preferably 2, still more preferably 1.9, still more preferably 1.85, still more preferably 1.8, still more preferably 1.75, still more preferably 1.71, and still more preferably 1.67.

In a configuration in which the L1r lens having positive refractive power is disposed on the extreme image side of the first lens group G1, it is preferable that the imaging lens satisfy Conditional Expression (20). Here, the refractive index of the L1r lens at the d line is denoted by Nd1r. By preventing the corresponding value of Conditional Expression (20) from becoming equal to or less than the lower limit value, it is possible to suppress the absolute value of the curvature radius of the L1r lens from becoming excessively small, thereby making it easier to secure the peripheral thickness of the L1r lens. By preventing the corresponding value of Conditional Expression (20) from becoming equal to or greater than the upper limit value, it is possible to select a low-dispersion material for the L1r lens, which is advantageous for chromatic aberration correction.

$$5 < Nd 1 r < 2.4 \qquad ( 20 )$$

In order to obtain more favorable characteristics, a lower limit value of Conditional Expression (20) is more preferably 1.6, still more preferably 1.65, still more preferably 1.7, still more preferably 1.74, still more preferably 1.77, still more preferably 1.8, and still more preferably 1.82. In order to obtain more favorable characteristics, an upper limit value of Conditional Expression (20) is more preferably 2.2, still more preferably 2, still more preferably 1.93, still more preferably 1.9, still more preferably 1.89, still more preferably 1.87, and still more preferably 1.86.

In a configuration in which the L1 lens having negative refractive power is disposed on the extreme object side of the first lens group G1 and the L1r lens having positive refractive power is disposed on the extreme image side of the first lens group G1, it is preferable that the imaging lens satisfy Conditional Expressions (19) and (20) at the same time.

Further, in a configuration in which an L1 lens having negative refractive power is disposed on the extreme object side of the first lens group G1, and an L1r lens having positive refractive power is disposed on the extreme image side of the first lens group G1, it is preferable that the imaging lens satisfy Conditional Expression (21). Here, the Abbe number of the L1 lens based on the d line is denoted by vd1. The Abbe number of the L1r lens based on the d line is denoted by vd1r. By preventing the corresponding value of Conditional Expression (21) from becoming equal to or less than the negative lower limit value, correction of lateral chromatic aberration is facilitated. By preventing the corresponding value of Conditional Expression (21) from becoming equal to or greater than the positive upper limit value, overcorrection of lateral chromatic aberration can be suppressed.

$$- 20 < vd 1 - vd 1 r < 30 \qquad ( 21 )$$

In order to obtain more favorable characteristics, the lower limit value of Conditional Expression (21) is more preferably −15, still more preferably −13, still more preferably −11, still more preferably −9, still more preferably −7, still more preferably −5, still more preferably −3, and still more preferably −1. In order to obtain more favorable characteristics, the upper limit value of Conditional Expression (21) is more preferably 25, still more preferably 22, still more preferably 19, still more preferably 17, still more preferably 15, still more preferably 13, still more preferably 11, and still more preferably 9.

In a configuration in which the second lens group G2 includes the cemented lens and the cemented lens includes the positive lens, it is preferable that the imaging lens satisfy Conditional Expression (22). Here, it is assumed that a temperature coefficient of the refractive index of the positive lens included in an extreme object-side cemented lens among the cemented lenses included in the second lens group G2 at the d line at a temperature of 25° C. is (dNp/dT)×10⁻⁶. It is assumed that dNp/dT is in units of ° C.⁻¹. By preventing the corresponding value of Conditional Expression (22) from becoming equal to or less than the lower limit value, correction of variations in off-axis aberrations due to temperature changes is facilitated. By preventing the corresponding value of Conditional Expression (22) from becoming equal to or greater than the upper limit value, overcorrection of variations in off-axis aberrations due to temperature changes can be suppressed.

$$2 < dNp / dT < 7 \qquad ( 22 )$$

In order to obtain more favorable characteristics, the lower limit value of Conditional Expression (22) is more preferably 2.5, still more preferably 3, and still more preferably 3.3. In order to obtain more favorable characteristics, an upper limit value of Conditional Expression (22) is more preferably 5, still more preferably 4.5, and still more preferably 4.1.

The preferred configurations and available configurations described above can be combined in any manner without inconsistency, and it is preferable that the preferred configurations and available configurations described above be selectively adopted as appropriate in accordance with required specifications.

For example, a preferred aspect of the present disclosure is an imaging lens consisting of, in order from the object side toward the image side, the first lens group G1, the aperture stop St, and the second lens group G2, in which the second lens group G2 includes two or more lenses that satisfy Conditional Expression (1).

Next, examples of the imaging lens according to the present disclosure will be described with reference to the drawings. In addition, reference numerals provided to the groups and the lenses in the cross-sectional view of each example are independently used for each example in order to avoid complication of description and the drawings caused by an increasing number of digits of the reference numerals. Accordingly, even in a case in which a common reference numeral is provided in the drawings of different examples, the common reference numeral does not always indicate a common configuration.

### Example 1

Since a cross-sectional view of the configuration of the imaging lens according to Example 1 is shown in FIG. 1, and its showing method and configuration are the same as described above, the duplicate descriptions will be partially omitted. The imaging lens according to Example 1 consists of, in order from the object side toward the image side, a first lens group G1 having positive refractive power, an aperture stop St, and a second lens group G2 having positive refractive power. During focusing on the short range object from the infinite distance object, the entire imaging lens moves integrally toward the object side along the optical axis Z.

For the imaging lens according to Example 1, Table 1 shows basic lens data, Table 2 shows specifications and a variable surface spacing, and Table 3 shows aspherical coefficients.

The table of the basic lens data is described as follows. The column of “Sn” indicates surface numbers in a case in which the number is increased by one at a time toward the image side from the extreme object-side surface as a first surface. The column of “R” indicates a curvature radius of each surface. The column of “D” indicates a surface spacing on the optical axis between each surface and its adjacent surface on the image side. The column of “Nd” indicates a refractive index at the d line for each lens. The column of “vd” indicates an Abbe number based on the d line for each lens. The column of “θg,F” indicates a partial dispersion ratio of each lens between the g line and the F line. The column of “dN/dT” shows a value obtained by multiplying the temperature coefficient of the refractive index of each lens at the d line at the temperature of 25° C. by 10⁶. The unit of dN/dT is ° C.⁻¹. The column of “ED” shows an effective diameter of each surface.

In addition, in a case in which refractive indexes of a certain lens at a g line, an F line, and a C line are denoted by Ng, NF, and NC, respectively, and a partial dispersion ratio of the lens between the g line and the F line is denoted by θg,F, θg,F is defined as the following expression.

$$θ g , F = ( Ng - NF ) / ( NF - NC )$$

In the table of the basic lens data, a sign of a curvature radius of a surface having a convex shape facing the object side is defined as positive, and a sign of a curvature radius of a surface having a convex shape facing the image side is defined as negative. The field of a surface number of the surface corresponding to the aperture stop St has the term of the surface number (St). A value in the lowermost field of the column of D in the table indicates a spacing between the extreme image-side surface in the table and the image plane Sim. A symbol DD [ ] is used for the variable surface spacing during focusing, and a surface number on the object side of the spacing is provided in [ ] in the column of the surface spacing.

For the imaging lens according to Example 1, Table 2 shows the focal length, the back focus, the open F-number FNo, the maximum full angle of view 20, and the variable surface spacing during focusing based on the d line. In the field of the maximum full angle of view, [°] indicates that the unit is degrees. In Table 2, the column of “infinite distance” shows each value in a state in which the infinite distance object is in focus, and the column of “short range −0.16×” shows each value in a state in which the short range object of which the imaging magnification is −0.16× is in focus.

In the basic lens data, the reference sign * is attached to the surface number of the aspherical surface, and the numerical value of the paraxial curvature radius is written into the field of the curvature radius of the aspherical surface. In Table 3, the row of Sn shows surface numbers of the aspherical surfaces, and the rows of KA and Am (m=3, 4, 5, . . . , 12) show numerical values of the aspherical coefficients for each aspherical surface. In Table 3, “E+n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: aspherical surface depth (a length of a perpendicular line drawn from a point on the aspheric surface at height h to a plane perpendicular to the optical axis Z where the apex of the aspheric surface is in contact),
h: height (distance from optical axis Z to lens surface),
C: reciprocal of paraxial curvature radius, and
KA, Am: aspherical coefficients,
and Σ means the sum with respect to m in aspherical surface equation.

In the data of each table, degrees are used as a unit of angles, and a millimeter (mm) is used for a unit of lengths, but, since the optical system can also be proportionally enlarged or proportionally reduced to be used, other appropriate units can also be used. In addition, the numerical values rounded to predetermined digits are described in each table shown below.

TABLE 1
Example 1

| Sn | R | D | Nd | νd | θg, F | dN/dT | ED |
|---|---|---|---|---|---|---|---|
| 1 | −22.8998 | 0.500 | 1.60342 | 38.01 | 0.5828 | 2.7 | 13.98 |
| 2 | 15.3459 | 0.574 | | | | | 12.83 |
| *3 | 16.1396 | 3.891 | 1.85135 | 40.10 | 0.5695 | 7.6 | 12.80 |
| *4 | −25.2000 | 1.000 | | | | | 12.72 |
| 5(St) | ∞ | 2.811 | | | | | 12.23 |
| 6 | −18.0243 | 0.500 | 1.51742 | 52.15 | 0.5590 | 0.6 | 11.81 |
| 7 | 9.8060 | 6.172 | 1.55397 | 71.76 | 0.5393 | −6.1 | 12.20 |
| 8 | −14.7433 | 0.150 | | | | | 12.40 |
| 9 | 14.5041 | 3.910 | 1.61997 | 63.88 | 0.5425 | −2.9 | 12.60 |
| 10 | −37.7114 | 0.510 | 1.58144 | 40.89 | 0.5768 | 3.4 | 12.61 |
| 11 | 12.8382 | 4.930 | | | | | 12.61 |
| 12 | −9.8292 | 0.528 | 1.62004 | 36.30 | 0.5873 | 2.1 | 13.19 |
| 13 | −66.4825 | 0.150 | | | | | 16.12 |
| *14 | 108.5545 | 4.317 | 1.85135 | 40.10 | 0.5695 | 7.6 | 19.31 |
| *15 | −19.1252 | DD[15] | | | | | 20.01 |

TABLE 2
Example 1

| | Infinite distance | Short range −0.16× |
|---|---|---|
| focal length | 23.71 | 23.71 |
| back focus | 11.081 | 14.874 |
| FNo. | 2.06 | 2.30 |
| 2ω[°] | 64.6 | 59.0 |
| DD[15] | 11.081 | 14.874 |

TABLE 3
Example 1

| Sn | 3 | 4 | 14 | 15 |
|---|---|---|---|---|
| KA | 1.0000000E+00 | 1.0000000E+00 | 1.0000000E+00 | 1.0000000E+00 |
| A3 | 8.2156785E−07 | 5.1399214E−19 | −3.3365080E−19 | 1.6682540E−19 |
| A4 | −2.0566834E−04 | −1.4992711E−04 | −9.3097163E−05 | −2.6972331E−06 |
| A5 | 1.2756840E−04 | 1.2457511E−04 | 6.9687644E−05 | 3.5638124E−05 |
| A6 | −4.0182776E−05 | −4.4046570E−05 | −1.2690000E−05 | −6.3940139E−06 |
| A7 | 5.5803723E−06 | 8.7461963E−06 | 5.2958716E−07 | 4.1830773E−07 |
| A8 | −3.8765977E−08 | −8.3641235E−07 | 1.3092698E−07 | 4.8651387E−08 |
| A9 | −6.5212859E−08 | −5.4924366E−08 | −1.6094445E−08 | −8.6803116E−09 |
| A10 | 4.0701800E−09 | 3.4695270E−08 | 5.7689327E−11 | 2.1717884E−10 |
| A11 | 1.1757830E−10 | −5.1775767E−09 | 7.5715856E−11 | 3.6066235E−11 |
| A12 | 5.2849578E−13 | 2.8413386E−10 | −3.2114640E−12 | −2.0896409E−12 |

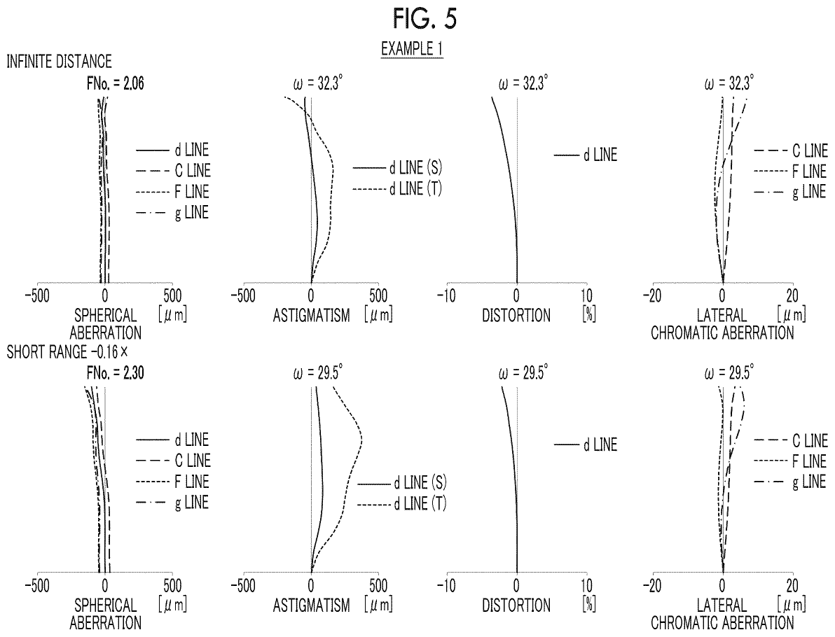

Each aberration diagram of the imaging lens according to Example 1 is shown in FIG. 5. The spherical aberration, the astigmatism, the distortion, and the lateral chromatic aberration are shown in this order from the left in FIG. 5. In FIG. 5, each aberration diagram in a state in which the infinite distance object is in focus is shown in an upper part labeled “infinite distance”, and each aberration diagram in a state in which the short range object of which the imaging magnification is −0.16× is in focus is shown in a lower part labeled “short range −0.16×”. In the spherical aberration diagram, the aberrations at the d line, the C line, the F line, and the g line are shown by a solid line, a long dashed line, a short dashed line, and a dash-dot line, respectively. In the astigmatism diagram, the aberration at the d line in a sagittal direction is shown by a solid line, and the aberration at the d line in a tangential direction is shown by a short dashed line. In the distortion diagram, the aberration at the d line is shown by a solid line. In the lateral chromatic aberration diagram, the aberrations at the C line, the F line, and the g line are shown by a long dashed line, a short dashed line, and a dash-dot line, respectively. In the spherical aberration diagram, a value of the open F-number is shown after “FNo.=”. In other aberration diagrams, a value of the maximum half angle of view is shown after “ω=”.

The symbols, definitions, and methods of representation used for Example 1 apply to the following examples unless otherwise specified; repetitive descriptions are omitted.

### Example 2

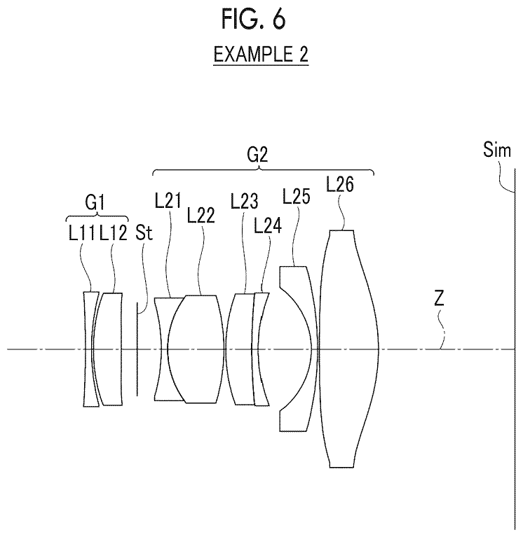

A cross-sectional view of a configuration of an imaging lens according to Example 2 is shown in FIG. 6. The imaging lens according to Example 2 consists of, in order from the object side toward the image side, a first lens group G1 having positive refractive power, an aperture stop St, and a second lens group G2 having positive refractive power. The first lens group G1 consists of, in order from the object side toward the image side, two lenses, that is, lenses L11 and L12. The second lens group G2 consists of, in order from the object side toward the image side, six lenses, that is, lenses L21 to L26. During focusing on the short range object from the infinite distance object, the entire imaging lens moves integrally toward the object side along the optical axis Z.

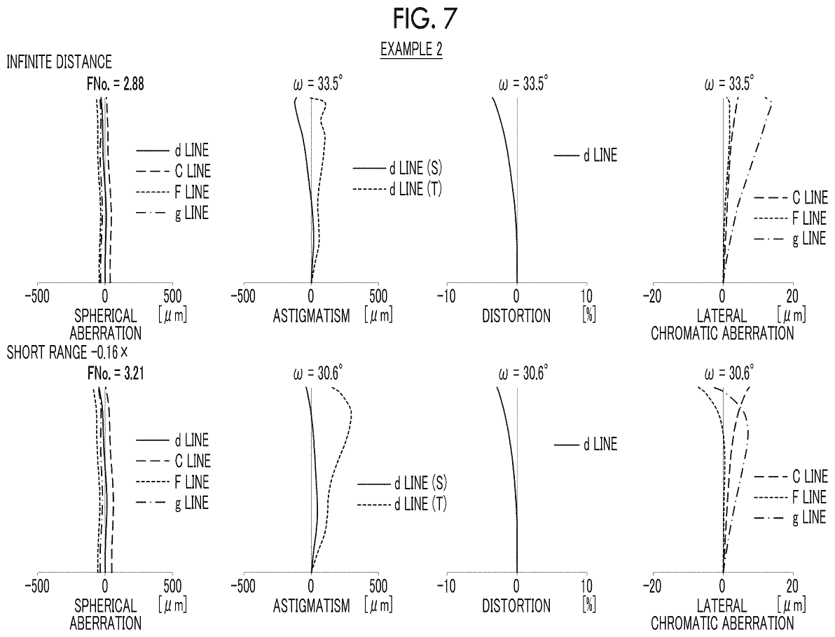

For the imaging lens according to Example 2, Table 4 shows basic lens data, Table 5 shows specifications and a variable surface spacing, Table 6 shows aspherical coefficients, and FIG. 7 shows each aberration diagram.

TABLE 4
Example 2

| Sn | R | D | Nd | νd | θg, F | dN/dT | ED |
|---|---|---|---|---|---|---|---|
| 1 | −75.4702 | 0.500 | 1.54072 | 47.20 | 0.5678 | 1.3 | 9.40 |
| 2 | 17.8262 | 0.150 | | | | | 9.09 |
| *3 | 14.2269 | 2.265 | 1.85135 | 40.10 | 0.5695 | 7.6 | 9.05 |
| *4 | −416.7267 | 1.294 | | | | | 8.42 |
| 5(St) | ∞ | 1.959 | | | | | 7.65 |
| 6 | −13.8471 | 0.510 | 1.56732 | 42.84 | 0.5744 | 3 | 7.77 |
| 7 | 7.2087 | 4.575 | 1.69680 | 55.46 | 0.5426 | 4.1 | 8.42 |
| 8 | −15.1954 | 0.150 | | | | | 8.80 |
| 9 | 13.4371 | 2.117 | 1.72916 | 54.67 | 0.5453 | 3.4 | 8.80 |
| 10 | 45.0885 | 0.510 | 1.71736 | 29.50 | 0.6040 | 2.5 | 9.06 |
| 11 | 12.7193 | 4.288 | | | | | 9.25 |
| 12 | −6.2838 | 0.500 | 1.60342 | 38.01 | 0.5828 | 2.1 | 10.13 |
| 13 | −25.2996 | 0.150 | | | | | 13.47 |
| *14 | 152.8419 | 4.806 | 1.85135 | 40.10 | 0.5695 | 7.6 | 18.50 |
| *15 | −14.8808 | DD[15] | | | | | 19.38 |

TABLE 5
Example 2

| | Infinite distance | Short range −0.16× |
|---|---|---|
| focal length | 22.99 | 22.99 |
| back focus | 11.086 | 14.764 |
| FNo. | 2.88 | 3.21 |
| 2ω[°] | 67.0 | 61.2 |
| DD[15] | 11.086 | 14.764 |

TABLE 6
Example 2

| Sn | 3 | 4 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 1.6291543E−20 | 0.0000000E+00 |
| A4 | 5.3919245E−05 | 9.1896595E−05 | −2.4388360E−05 | 8.5380273E−05 |
| A5 | −7.9023554E−05 | −6.2151317E−05 | 2.7243958E−05 | −1.2551058E−06 |
| A6 | 3.4556189E−05 | 2.4692514E−05 | −1.9073422E−06 | −1.5120719E−07 |
| A7 | −5.0128869E−07 | 2.2318554E−06 | −2.0040267E−07 | 3.7094217E−07 |
| A8 | −1.5335822E−06 | −1.6754402E−06 | 3.1691440E−08 | −2.2830708E−08 |
| A9 | 8.5773503E−08 | 7.4814702E−08 | 1.0466985E−10 | −3.3503428E−09 |
| A10 | 4.1986730E−08 | 3.9223199E−08 | −1.3963737E−10 | 3.8155967E−10 |
| A11 | −1.2243954E−09 | −1.3715990E−09 | 2.8158903E−12 | 8.9226016E−12 |
| A12 | −4.5716370E−10 | −2.5399267E−10 | 4.6618147E−14 | −1.5516345E−12 |

### Example 3

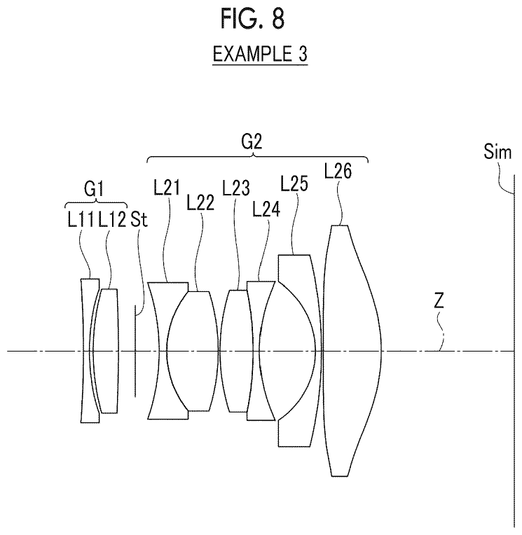

A cross-sectional view of a configuration of an imaging lens according to Example 3 is shown in FIG. 8. The imaging lens according to Example 3 consists of, in order from the object side toward the image side, a first lens group G1 having positive refractive power, an aperture stop St, and a second lens group G2 having positive refractive power. The first lens group G1 consists of, in order from the object side toward the image side, two lenses, that is, lenses L11 and L12. The second lens group G2 consists of, in order from the object side toward the image side, six lenses, that is, lenses L21 to L26. During focusing on the short range object from the infinite distance object, the entire imaging lens moves integrally toward the object side along the optical axis Z.

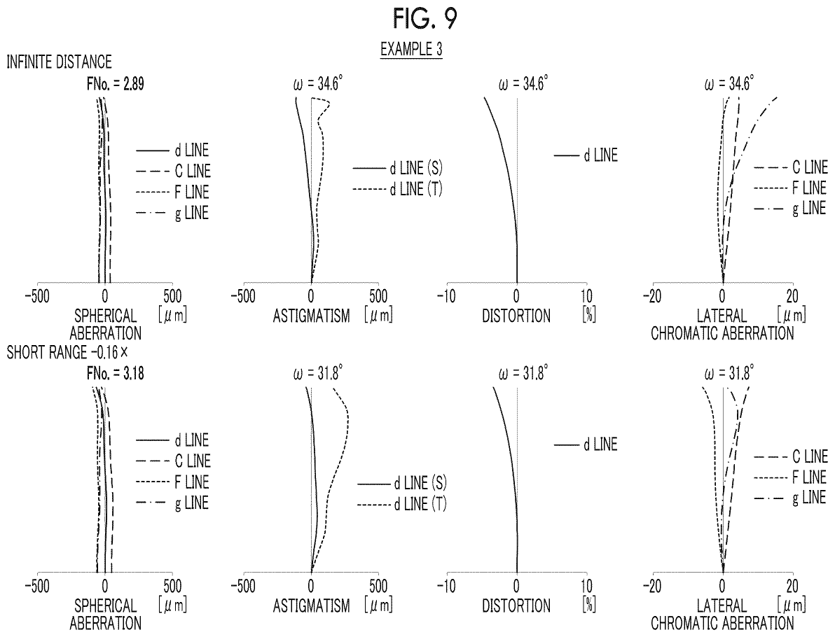

For the imaging lens according to Example 3, Table 7 shows basic lens data, Table 8 shows specifications and a variable surface spacing, Table 9 shows aspherical coefficients, and FIG. 9 shows each aberration diagram.

TABLE 7
Example 3

| Sn | R | D | Nd | νd | θg, F | dN/dT | ED |
|---|---|---|---|---|---|---|---|
| *1 | −312.3867 | 0.500 | 1.51633 | 64.06 | 0.5334 | 4.7 | 9.40 |
| *2 | 16.1136 | 0.318 | | | | | 9.05 |
| 3 | 19.4592 | 2.103 | 1.85033 | 42.70 | 0.5646 | 4.5 | 9.01 |
| 4 | −106.8956 | 1.404 | | | | | 8.57 |
| 5(St) | ∞ | 1.994 | | | | | 7.63 |
| 6 | −17.3520 | 0.626 | 1.58144 | 40.89 | 0.5768 | 3.4 | 7.83 |
| 7 | 7.8813 | 4.295 | 1.69680 | 55.46 | 0.5426 | 4.1 | 8.42 |
| 8 | −16.5785 | 0.150 | | | | | 8.80 |
| 9 | 17.0455 | 2.756 | 1.75500 | 52.32 | 0.5474 | 4.1 | 8.80 |
| 10 | −26.1896 | 0.510 | 1.60342 | 38.01 | 0.5828 | 2.7 | 9.22 |
| 11 | 13.5649 | 4.643 | | | | | 9.63 |
| 12 | −6.9927 | 0.500 | 1.62004 | 36.30 | 0.5873 | 2.1 | 10.82 |
| 13 | −33.5864 | 0.150 | | | | | 14.17 |
| *14 | 795.0184 | 4.837 | 1.85135 | 40.10 | 0.5695 | 7.6 | 17.65 |
| *15 | −13.9726 | DD[15] | | | | | 18.94 |

TABLE 8
Example 3

| | Infinite | Short range |
|---|---|---|
| | distance | −0.16× |
| focal length | 22.33 | 22.33 |
| back focus | 11.088 | 14.661 |
| FNo. | 2.89 | 3.18 |
| 2ω[°] | 69.2 | 63.6 |
| DD[15] | 11.088 | 14.661 |

TABLE 9
Example 3

| Sn | 1 | 2 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −5.3203461E−04 | −5.0709534E−04 | −3.1882805E−05 | 7.8757233E−05 |
| A5 | −1.2389161E−04 | −7.6325121E−05 | 2.6108233E−05 | −2.3641119E−06 |
| A6 | 7.3680789E−05 | 4.3344523E−05 | −2.4579835E−06 | −7.9659909E−07 |
| A7 | 3.6394793E−06 | 1.1235677E−05 | −1.4264425E−07 | 5.4054086E−07 |
| A8 | −3.3193079E−06 | −3.2936572E−06 | 4.0500913E−08 | −3.4337873E−08 |
| A9 | −5.5733677E−08 | −2.9654563E−07 | −6.8123587E−10 | −5.9821053E−09 |
| A10 | 7.6287372E−08 | 9.0251609E−08 | −1.7580366E−10 | 7.0827042E−10 |
| A11 | 2.2588601E−10 | 2.6034700E−09 | 5.9258312E−12 | 1.9409399E−11 |
| A12 | −6.9747136E−10 | −7.9594239E−10 | −4.4257670E−14 | −3.2090859E−12 |

### Example 4

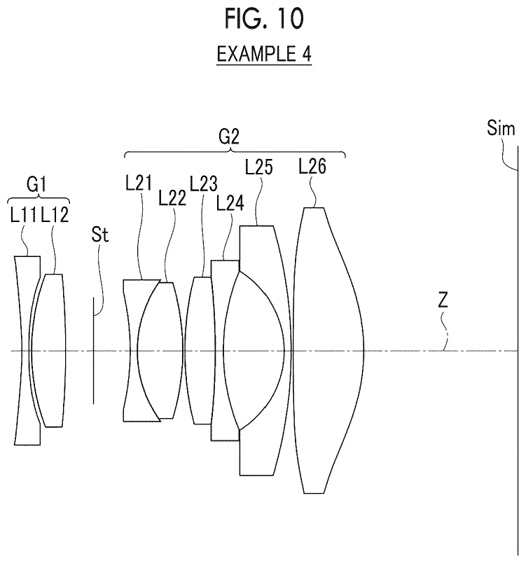

A cross-sectional view of a configuration of an imaging lens according to Example 4 is shown in FIG. 10. The imaging lens according to Example 4 consists of, in order from the object side toward the image side, a first lens group G1 having positive refractive power, an aperture stop St, and a second lens group G2 having positive refractive power. The first lens group G1 consists of, in order from the object side toward the image side, two lenses, that is, lenses L11 and L12. The second lens group G2 consists of, in order from the object side toward the image side, six lenses, that is, lenses L21 to L26. During focusing on the short range object from the infinite distance object, the entire imaging lens moves integrally toward the object side along the optical axis Z.

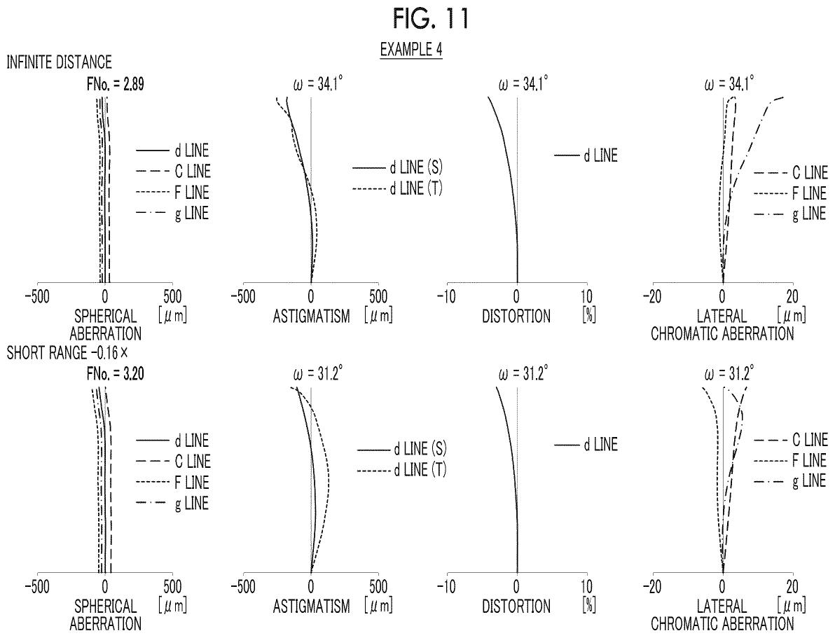

For the imaging lens according to Example 4, Table 10 shows basic lens data, Table 11 shows specifications and a variable surface spacing, Table 12 shows aspherical coefficients, and FIG. 11 shows each aberration diagram.

TABLE 10
Example 4

| Sn | R | D | Nd | νd | θg, F | dN/dT | ED |
|---|---|---|---|---|---|---|---|
| *1 | −23.0829 | 0.500 | 1.51625 | 64.05 | 0.5362 | 1.5 | 10.75 |
| *2 | 29.8180 | 0.200 | | | | | 9.77 |
| 3 | 15.6900 | 2.440 | 1.77250 | 49.60 | 0.5513 | 3.3 | 9.60 |
| 4 | −60.9873 | 2.010 | | | | | 9.13 |
| 5(St) | ∞ | 2.640 | | | | | 7.63 |
| 6 | −18.3310 | 0.510 | 1.73037 | 32.23 | 0.5900 | 3.2 | 7.36 |
| 7 | 8.5700 | 3.270 | 1.87070 | 40.73 | 0.5683 | 3.9 | 7.55 |
| 8 | −16.9000 | 0.150 | | | | | 7.60 |
| 9 | 21.2106 | 2.190 | 1.81600 | 46.55 | 0.5570 | 3.8 | 8.52 |
| 10 | −47.7372 | 0.580 | 1.64769 | 33.89 | 0.5939 | 2 | 8.92 |
| 11 | 14.8411 | 4.340 | | | | | 9.32 |
| 12 | −6.7821 | 0.500 | 1.62004 | 36.33 | 0.5886 | 3.7 | 10.48 |
| 13 | −31.8496 | 0.150 | | | | | 13.78 |
| *14 | 299.7330 | 5.070 | 1.80610 | 40.73 | 0.5694 | 7.9 | 17.57 |
| *15 | −13.4793 | DD[15] | | | | | 18.95 |

TABLE 11
Example 4

| | Infinite | Short range |
|---|---|---|
| | distance | −0.16× |
| focal length | 22.66 | 22.66 |
| back focus | 11.087 | 14.713 |
| FNo. | 2.89 | 3.20 |
| 2ω[°] | 68.2 | 62.4 |
| DD[15] | 11.087 | 14.713 |

TABLE 12
Example 4

| Sn | 1 | 2 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.1226147E−03 | 1.1964522E−03 | −2.7443399E−05 | 9.1264375E−05 |
| A5 | −1.9157957E−04 | −1.6288717E−04 | 2.6885205E−05 | −1.5616014E−05 |
| A6 | −1.2766505E−05 | −3.4902243E−05 | −3.9800796E−06 | 4.6937102E−06 |
| A7 | 6.9813870E−06 | 1.5458763E−05 | 2.9305541E−07 | −2.9587550E−07 |
| A8 | −4.3618155E−07 | −1.1213070E−06 | 2.5921703E−08 | −4.2601946E−08 |
| A9 | −1.0137755E−07 | −4.1893051E−07 | −6.7361888E−09 | 8.8943653E−09 |
| A10 | 1.5171764E−08 | 7.1304503E−08 | 2.2504505E−10 | −1.4996174E−10 |
| A11 | 4.9434044E−10 | 3.5611475E−09 | 2.9713715E−11 | −4.5591662E−11 |
| A12 | −1.3773934E−10 | −9.1395772E−10 | −1.8870809E−12 | 1.9938901E−12 |

### Example 5

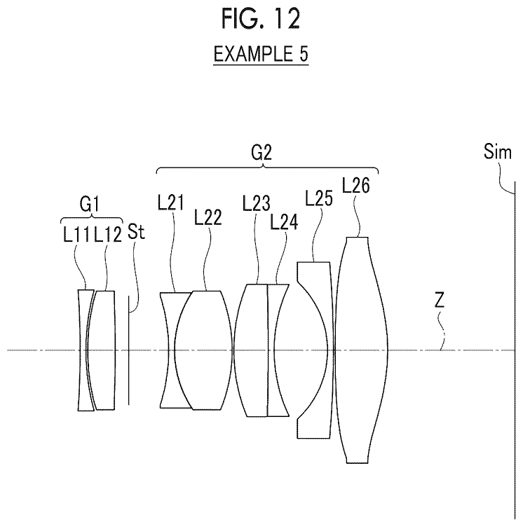

A cross-sectional view of a configuration of an imaging lens according to Example 5 is shown in FIG. 12. The imaging lens according to Example 5 consists of, in order from the object side toward the image side, a first lens group G1 having positive refractive power, an aperture stop St, and a second lens group G2 having positive refractive power. The first lens group G1 consists of, in order from the object side toward the image side, two lenses, that is, lenses L11 and L12. The second lens group G2 consists of, in order from the object side toward the image side, six lenses, that is, lenses L21 to L26. During focusing on the short range object from the infinite distance object, the entire imaging lens moves integrally toward the object side along the optical axis Z.

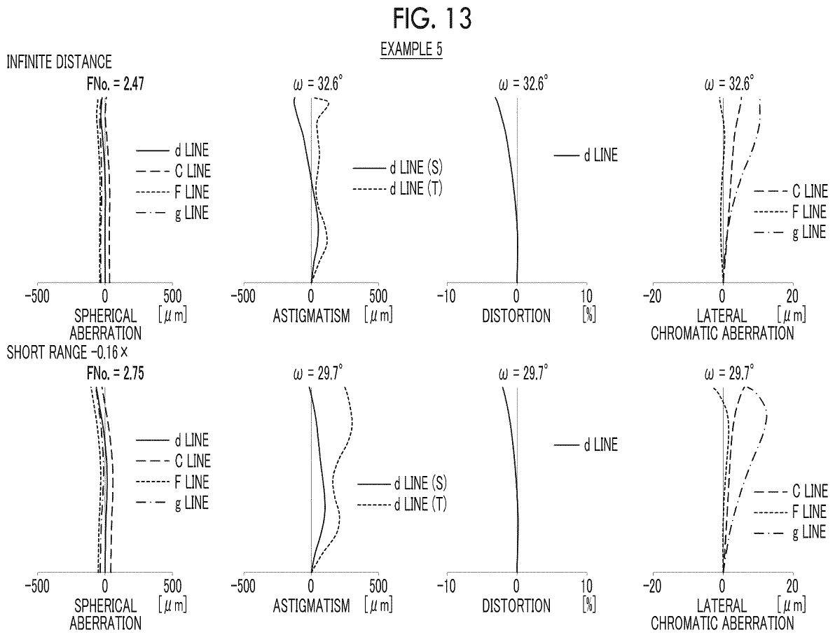

For the imaging lens according to Example 5, Table 13 shows basic lens data, Table 14 shows specifications and a variable surface spacing, Table 15 shows aspherical coefficients, and FIG. 13 shows each aberration diagram.

TABLE 13
Example 5

| Sn | R | D | Nd | νd | θg, F | dN/dT | ED |
|---|---|---|---|---|---|---|---|
| 1 | −71.3872 | 0.500 | 1.60342 | 38.01 | 0.5828 | 2.7 | 10.60 |
| 2 | 20.1006 | 0.150 | | | | | 10.38 |
| *3 | 18.4554 | 2.401 | 1.85135 | 40.10 | 0.5695 | 7.6 | 10.40 |
| *4 | −94.2001 | 1.169 | | | | | 10.00 |
| 5(St) | ∞ | 3.484 | | | | | 9.50 |
| 6 | −15.7880 | 0.510 | 1.51742 | 52.15 | 0.5590 | 0.6 | 9.52 |
| 7 | 9.2452 | 5.012 | 1.61997 | 63.88 | 0.5425 | −2.9 | 10.11 |
| 8 | −13.8532 | 0.150 | | | | | 10.40 |
| 9 | 15.3065 | 2.953 | 1.85033 | 42.70 | 0.5646 | 4.5 | 11.60 |
| 10 | −200.7461 | 0.510 | 1.71736 | 29.50 | 0.6040 | 2.5 | 11.57 |
| 11 | 13.3617 | 4.651 | | | | | 11.52 |
| 12 | −8.2254 | 0.508 | 1.62004 | 36.30 | 0.5873 | 2.1 | 12.05 |
| 13 | −90.1652 | 0.150 | | | | | 15.43 |
| *14 | 86.3623 | 4.572 | 1.85135 | 40.10 | 0.5695 | 7.6 | 19.02 |
| *15 | −17.6298 | DD[15] | | | | | 19.79 |

TABLE 14
Example 5

| | Infinite | Short range |
|---|---|---|
| | distance | −0.16× |
| focal length | 23.71 | 23.71 |
| back focus | 11.087 | 14.880 |
| FNo. | 2.47 | 2.75 |
| 2ω[°] | 65.2 | 59.4 |
| DD[15] | 11.087 | 14.880 |

TABLE 15
Example 5

| Sn | 3 | 4 | 14 | 15 |
|---|---|---|---|---|
| KA | 1.0000000E+00 | 1.0000000E+00 | 1.0000000E+00 | 1.0000000E+00 |
| A3 | 8.0920046E−20 | 0.0000000E+00 | 3.3365080E−19 | −1.6682540E−19 |
| A4 | −5.3593887E−05 | −1.8976165E−05 | −1.1976717E−04 | 3.4096597E−05 |
| A5 | −1.2526520E−05 | −1.7441293E−05 | 6.5673561E−05 | 1.6752711E−05 |
| A6 | 1.1753786E−05 | 1.8440514E−05 | −9.0913281E−06 | −4.0339539E−06 |
| A7 | −1.0414234E−06 | −2.8267955E−06 | 9.7798580E−08 | 6.1243635E−07 |
| A8 | −3.3854251E−07 | −3.8844700E−07 | 1.0753924E−07 | 6.2021950E−09 |
| A9 | 4.9433759E−08 | 1.4834327E−07 | −9.3528948E−09 | −9.1779890E−09 |
| A10 | 4.7331501E−09 | −4.8473807E−09 | −9.7297260E−11 | 5.2600493E−10 |
| A11 | −4.9498772E−10 | −1.7532423E−09 | 4.8056602E−11 | 3.4981871E−11 |
| A12 | −1.6012995E−11 | 1.7664454E−10 | −1.9028635E−12 | −2.9319442E−12 |

### Example 6

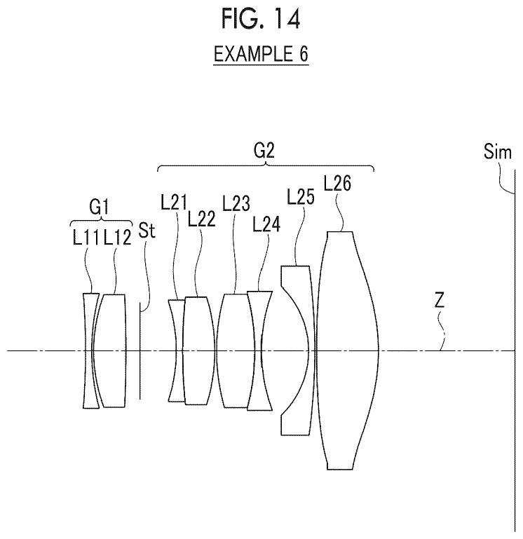

A cross-sectional view of a configuration of an imaging lens according to Example 6 is shown in FIG. 14. The imaging lens according to Example 6 consists of, in order from the object side toward the image side, a first lens group G1 having positive refractive power, an aperture stop St, and a second lens group G2 having positive refractive power. The first lens group G1 consists of, in order from the object side toward the image side, two lenses, that is, lenses L11 and L12. The second lens group G2 consists of, in order from the object side toward the image side, six lenses, that is, lenses L21 to L26. During focusing on the short range object from the infinite distance object, the entire imaging lens moves integrally toward the object side along the optical axis Z.

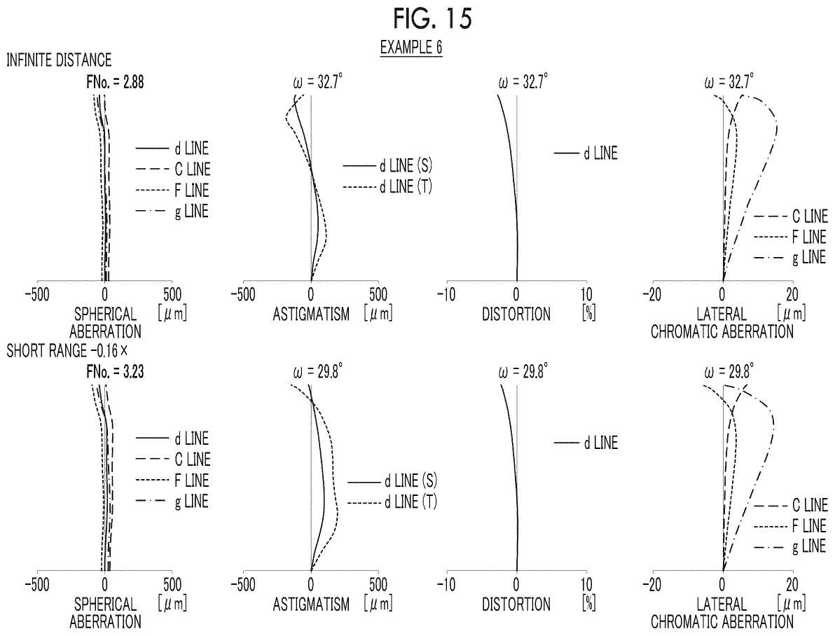

For the imaging lens according to Example 6, Table 16 shows basic lens data, Table 17 shows specifications and a variable surface spacing, Table 18 shows aspherical coefficients, and FIG. 15 shows each aberration diagram.

TABLE 16
Example 6

| Sn | R | D | Nd | νd | θg, F | dN/dT | ED |
|---|---|---|---|---|---|---|---|
| 1 | −58.8313 | 0.500 | 1.62004 | 36.30 | 0.5873 | 2.1 | 9.40 |
| 2 | 18.3226 | 0.150 | | | | | 9.18 |
| *3 | 12.6158 | 2.621 | 1.85135 | 40.10 | 0.5695 | 7.6 | 9.20 |
| *4 | −129.3628 | 1.147 | | | | | 8.69 |
| 5(St) | ∞ | 2.948 | | | | | 7.88 |
| 6 | −12.9089 | 0.510 | 1.58144 | 40.89 | 0.5768 | 3.4 | 7.92 |
| 7 | 40.8121 | 2.608 | 1.69680 | 55.46 | 0.5426 | 4.1 | 8.32 |
| 8 | −14.9902 | 0.150 | | | | | 8.77 |
| 9 | 16.9547 | 3.098 | 1.85033 | 42.70 | 0.5646 | 4.5 | 8.80 |
| 10 | −18.1249 | 0.510 | 1.69895 | 30.05 | 0.6028 | 2.5 | 9.28 |
| 11 | 13.9117 | 3.821 | | | | | 9.72 |
| 12 | −7.3356 | 0.500 | 1.60342 | 38.01 | 0.5828 | 2.7 | 10.53 |
| 13 | −51.3710 | 0.150 | | | | | 13.80 |
| *14 | 68.4686 | 5.016 | 1.85135 | 40.10 | 0.5695 | 7.6 | 18.33 |
| *15 | −16.2132 | DD[15] | | | | | 19.42 |

TABLE 17
Example 6

| | Infinite | Short range |
|---|---|---|
| | distance | −0.16× |
| focal length | 23.57 | 23.57 |
| back focus | 11.082 | 14.854 |
| FNo. | 2.88 | 3.23 |
| 2ω[°] | 65.4 | 59.6 |
| DD[15] | 11.082 | 14.854 |

TABLE 18
Example 6

| Sn | 3 | 4 | 14 | 15 |
|---|---|---|---|---|
| KA | 1.0000000E+00 | 1.0000000E+00 | 1.0000000E+00 | 1.0000000E+00 |
| A3 | 0.0000000E+00 | −1.6184009E−19 | 1.4597222E−19 | 4.1706350E−20 |
| A4 | −8.6631110E−05 | −7.2417666E−05 | −1.1034396E−04 | 7.1084313E−05 |
| A5 | −1.2130841E−05 | 1.4345434E−05 | 3.3551868E−05 | −8.6986111E−06 |
| A6 | 1.8033686E−05 | 1.0045702E−06 | −1.1902134E−06 | 6.5160920E−07 |
| A7 | −5.6055188E−06 | −1.3102037E−06 | −4.0356194E−07 | 4.0342480E−07 |
| A8 | 1.3930771E−07 | 7.0084433E−08 | 3.6772565E−08 | −3.6849269E−08 |
| A9 | 1.7336614E−07 | 7.7433314E−08 | 2.1537738E−09 | −3.4484027E−09 |
| A10 | −1.6560830E−08 | −1.5118352E−08 | −2.6638584E−10 | 4.6948218E−10 |
| A11 | −1.6695268E−09 | −9.5214648E−10 | −4.0369545E−12 | 9.4573022E−12 |
| A12 | 1.8221959E−10 | 2.9789222E−10 | 6.1370300E−13 | −1.7336454E−12 |

### Example 7

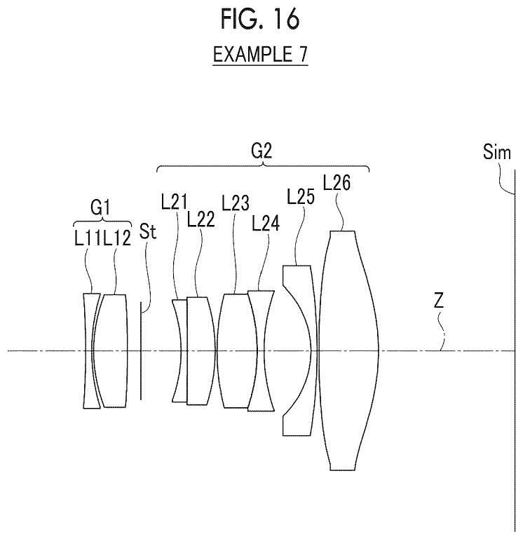

A cross-sectional view of a configuration of an imaging lens according to Example 7 is shown in FIG. 16. The imaging lens according to Example 7 consists of, in order from the object side toward the image side, a first lens group G1 having positive refractive power, an aperture stop St, and a second lens group G2 having positive refractive power. The first lens group G1 consists of, in order from the object side toward the image side, two lenses, that is, lenses L11 and L12. The second lens group G2 consists of, in order from the object side toward the image side, six lenses, that is, lenses L21 to L26. During focusing on the short range object from the infinite distance object, the entire imaging lens moves integrally toward the object side along the optical axis Z.

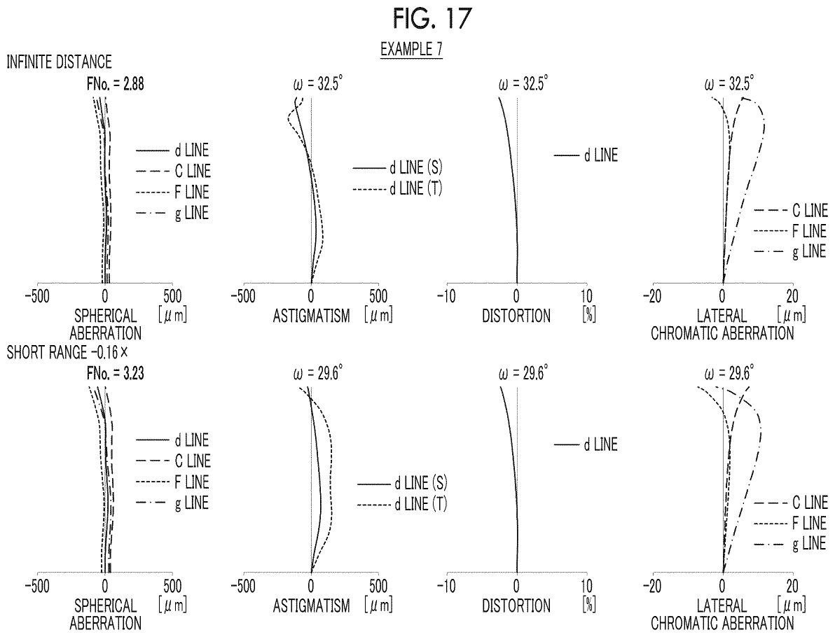

For the imaging lens according to Example 7, Table 19 shows basic lens data, Table 20 shows specifications and a variable surface spacing, Table 21 shows aspherical coefficients, and FIG. 17 shows each aberration diagram.

TABLE 19
Example 7

| Sn | R | D | Nd | νd | θg, F | dN/dT | ED |
|---|---|---|---|---|---|---|---|
| 1 | −65.7540 | 0.500 | 1.64769 | 33.84 | 0.5924 | 1.4 | 9.40 |
| 2 | 15.8432 | 0.150 | | | | | 9.16 |
| *3 | 12.0561 | 2.743 | 1.85135 | 40.10 | 0.5695 | 7.6 | 9.20 |
| *4 | −85.9145 | 1.090 | | | | | 8.75 |
| 5(St) | ∞ | 3.271 | | | | | 7.97 |
| 6 | −11.6959 | 0.510 | 1.51742 | 52.15 | 0.5590 | 0.6 | 8.00 |
| 7 | −343.0638 | 2.260 | 1.72916 | 54.67 | 0.5453 | 3.4 | 8.36 |
| 8 | −14.4831 | 0.150 | | | | | 8.79 |
| 9 | 18.4187 | 3.269 | 1.85033 | 42.70 | 0.5646 | 4.5 | 8.80 |
| 10 | −14.4502 | 0.510 | 1.72825 | 28.32 | 0.6076 | 2.7 | 9.32 |
| 11 | 14.8097 | 3.809 | | | | | 9.82 |
| 12 | −7.3702 | 0.500 | 1.58144 | 40.89 | 0.5768 | 3.4 | 10.64 |
| 13 | −43.3341 | 0.150 | | | | | 13.87 |
| *14 | 68.0428 | 4.837 | 1.85135 | 40.10 | 0.5695 | 7.6 | 18.55 |
| *15 | −17.2332 | DD[15] | | | | | 19.54 |

TABLE 20
Example 7

| | Infinite | Short range |
|---|---|---|
| | distance | −0.16× |
| focal length | 23.71 | 23.71 |
| back focus | 11.087 | 14.880 |
| FNo. | 2.88 | 3.23 |
| 2ω[°] | 65.0 | 59.2 |
| DD[15] | 11.087 | 14.880 |

TABLE 21
Example 7

| Sn | 3 | 4 | 14 | 15 |
|---|---|---|---|---|
| KA | 1.0000000E+00 | 1.0000000E+00 | 1.0000000E+00 | 1.0000000E+00 |
| A3 | 3.2368018E−19 | 0.0000000E+00 | 4.1706350E−20 | −2.2677828E−19 |
| A4 | −1.0646077E−04 | −9.1937185E−05 | −7.0874956E−05 | 7.3155755E−05 |
| A5 | −1.4073301E−05 | 2.4545758E−05 | 2.6811891E−05 | −8.0059424E−06 |
| A6 | 2.1827598E−05 | −6.6438388E−07 | −1.7738855E−06 | 1.0807885E−06 |
| A7 | −7.2257852E−06 | −2.7146755E−06 | −2.0585979E−07 | 2.5190770E−07 |
| A8 | 2.3944790E−07 | 4.1833580E−07 | 3.3756863E−08 | −3.4427058E−08 |
| A9 | 2.1608953E−07 | 1.0588374E−07 | 1.6666692E−10 | −1.1910537E−09 |
| A10 | −2.1947545E−08 | −2.6631934E−08 | −1.7189589E−10 | 3.3306839E−10 |
| A11 | −2.0713917E−09 | −1.1736942E−09 | 2.7934714E−12 | 6.2259936E−14 |
| A12 | 2.2848548E−10 | 4.0420769E−10 | 1.8528555E−13 | −9.9120797E−13 |

### Example 8

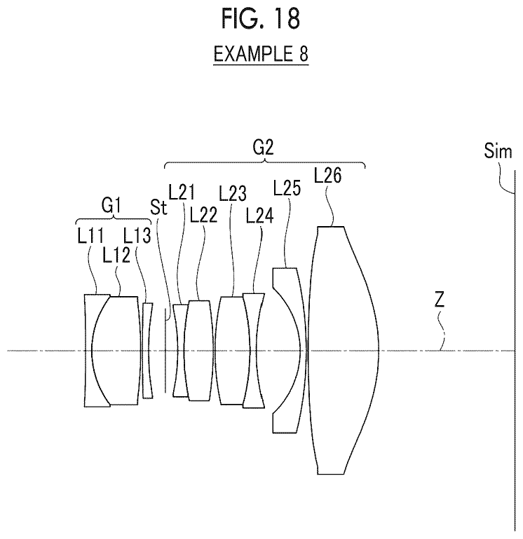

A cross-sectional view of a configuration of an imaging lens according to Example 8 is shown in FIG. 18. The imaging lens according to Example 8 consists of, in order from the object side toward the image side, a first lens group G1 having positive refractive power, an aperture stop St, and a second lens group G2 having positive refractive power. The first lens group G1 consists of, in order from the object side toward the image side, three lenses, that is, lenses L11 to L13. The second lens group G2 consists of, in order from the object side toward the image side, six lenses, that is, lenses L21 to L26. During focusing on the short range object from the infinite distance object, the entire imaging lens moves integrally toward the object side along the optical axis Z.

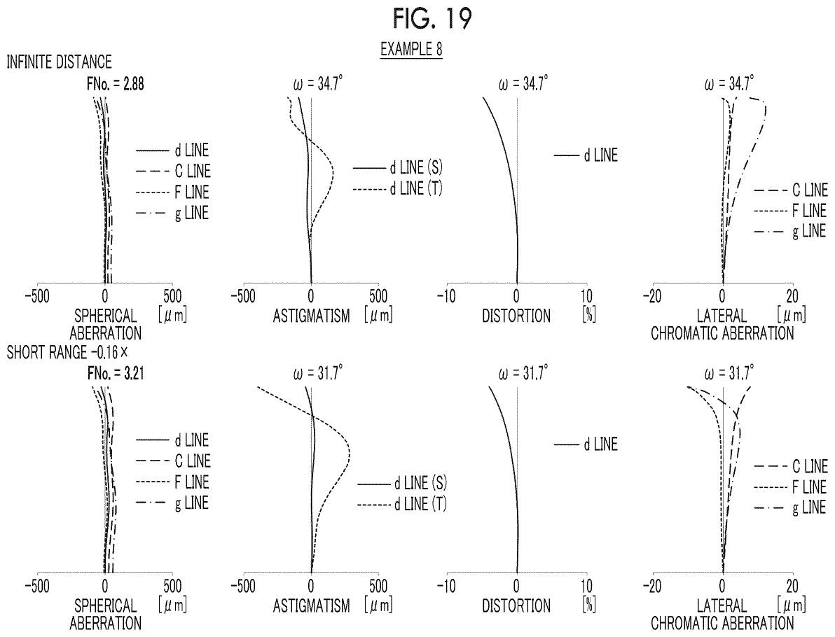

For the imaging lens according to Example 8, Table 22 shows basic lens data, Table 23 shows specifications and a variable surface spacing, Table 24 shows aspherical coefficients, and FIG. 19 shows each aberration diagram.

TABLE 22
Example 8

| Sn | R | D | Nd | νd | θg, F | dN/dT | ED |
|---|---|---|---|---|---|---|---|
| *1 | −416.7293 | 0.510 | 1.61340 | 44.27 | 0.5634 | 4.1 | 9.20 |
| 2 | 7.3069 | 3.979 | 1.85135 | 40.10 | 0.5695 | 7.6 | 8.86 |
| *3 | −34.2626 | 0.150 | | | | | 8.19 |
| 4 | 157.6973 | 0.500 | 1.80518 | 25.46 | 0.6157 | 0.9 | 7.81 |
| 5 | 22.2348 | 1.369 | | | | | 7.46 |
| 6(St) | ∞ | 1.000 | | | | | 6.87 |
| 7 | −16.9448 | 0.510 | 1.60342 | 38.01 | 0.5828 | 2.7 | 7.08 |
| 8 | 19.7988 | 2.378 | 1.90043 | 37.37 | 0.5767 | 4.2 | 7.55 |
| 9 | −25.4153 | 0.150 | | | | | 7.97 |
| 10 | 20.3388 | 2.841 | 1.90043 | 37.37 | 0.5767 | 4.2 | 8.20 |
| 11 | −17.1714 | 0.510 | 1.84666 | 23.78 | 0.6192 | 1.4 | 8.82 |
| 12 | 17.4693 | 3.531 | | | | | 9.38 |
| 13 | −7.1291 | 0.500 | 1.60342 | 38.01 | 0.5828 | 2.7 | 10.33 |
| 14 | −28.4909 | 0.150 | | | | | 13.47 |
| *15 | 75.1058 | 5.743 | 1.85135 | 40.10 | 0.5695 | 7.6 | 19.00 |
| *16 | −14.2987 | DD[16] | | | | | 20.26 |

TABLE 23
Example 8

| | Infinite | Short range |
|---|---|---|
| | distance | −0.16× |
| focal length | 22.33 | 22.33 |
| back focus | 11.083 | 14.655 |
| FNo. | 2.88 | 3.21 |
| 2ω[°] | 69.4 | 63.4 |
| DD[16] | 11.083 | 14.655 |

TABLE 24
Example 8

| Sn | 1 | 3 | 15 | 16 |
|---|---|---|---|---|
| KA | 1.0000000E+00 | 1.0000000E+00 | 1.0000000E+00 | 1.0000000E+00 |
| A3 | −4.4506025E−19 | 1.6184009E−19 | −1.6682540E−19 | 0.0000000E+00 |
| A4 | 1.2160153E−04 | 1.6629853E−04 | −1.3012571E−04 | 9.3910125E−05 |
| A5 | −2.3040446E−04 | −1.6557119E−04 | 3.5547826E−05 | −2.0718834E−05 |
| A6 | 5.4872506E−05 | 1.8781464E−05 | −2.4699740E−06 | 4.4454749E−06 |
| A7 | 4.4162303E−06 | 1.3588584E−05 | −1.5733332E−07 | −1.5113057E−07 |
| A8 | −2.8878518E−06 | −3.0625291E−06 | 3.7566946E−08 | −4.3184383E−08 |
| A9 | −3.5889823E−08 | −2.1531371E−07 | −1.6268850E−09 | 5.9594660E−09 |
| A10 | 7.7903227E−08 | 7.4087180E−08 | −9.6889798E−11 | −7.5323066E−11 |
| A11 | −2.7357831E−10 | 1.4682724E−09 | 1.1509106E−11 | −2.9397697E−11 |
| A12 | −8.5010102E−10 | −4.6277897E−10 | −2.7843671E−13 | 1.5173882E−12 |

### Example 9

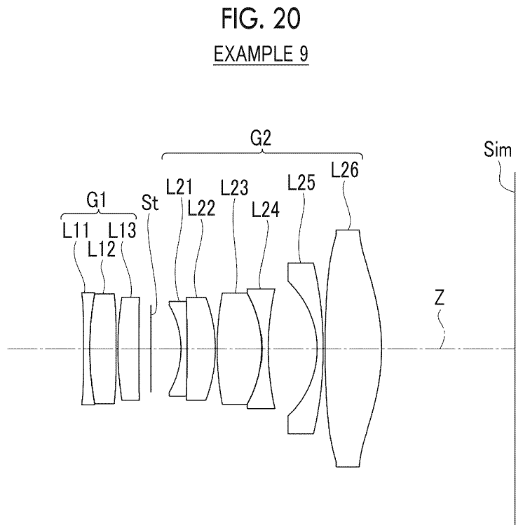

A cross-sectional view of a configuration of an imaging lens according to Example 9 is shown in FIG. 20. The imaging lens according to Example 9 consists of, in order from the object side toward the image side, a first lens group G1 having positive refractive power, an aperture stop St, and a second lens group G2 having positive refractive power. The first lens group G1 consists of, in order from the object side toward the image side, three lenses, that is, lenses L11 to L13. The second lens group G2 consists of, in order from the object side toward the image side, six lenses, that is, lenses L21 to L26. During focusing on the short range object from the infinite distance object, the entire imaging lens moves integrally toward the object side along the optical axis Z.

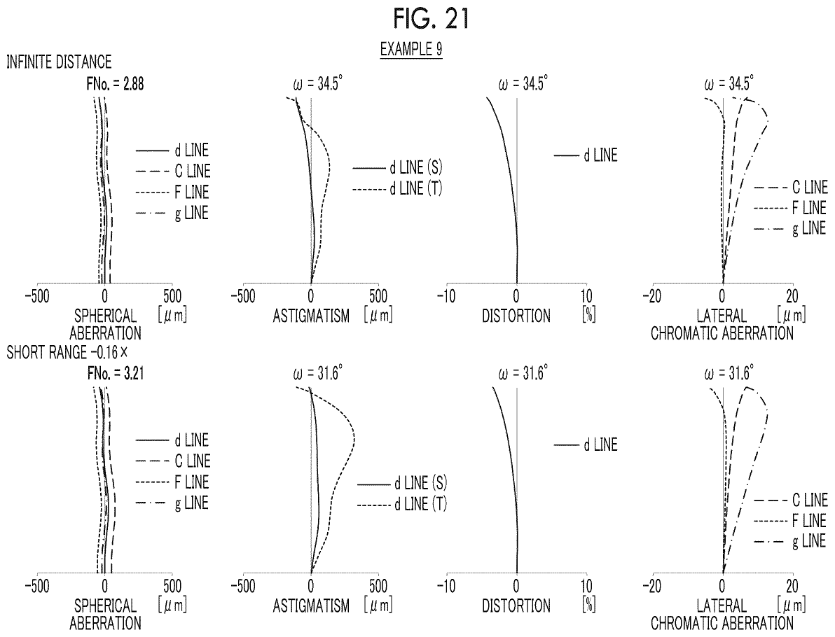

For the imaging lens according to Example 9, Table 25 shows basic lens data, Table 26 shows specifications and a variable surface spacing, Table 27 shows aspherical coefficients, and FIG. 21 shows each aberration diagram.

TABLE 25
Example 9

| Sn | R | D | Nd | νd | θg, F | dN/dT | ED |
|---|---|---|---|---|---|---|---|
| *1 | −416.6767 | 0.510 | 1.68948 | 31.02 | 0.5987 | 0.2 | 9.40 |
| 2 | 25.7537 | 2.192 | 1.82080 | 42.71 | 0.5643 | 6.1 | 9.21 |
| *3 | −416.7216 | 0.150 | | | | | 8.95 |
| 4 | 27.6761 | 1.750 | 1.78590 | 43.93 | 0.5612 | 8.2 | 8.63 |
| 5 | 333.6718 | 1.000 | | | | | 8.03 |
| 6(St) | ∞ | 2.502 | | | | | 7.28 |
| 7 | −7.2661 | 0.510 | 1.51742 | 52.15 | 0.5590 | 0.6 | 7.29 |
| 8 | −124.4572 | 2.341 | 1.91082 | 35.25 | 0.5833 | 4.8 | 7.93 |
| 9 | −12.2106 | 0.150 | | | | | 8.54 |
| 10 | 25.0807 | 3.706 | 1.88300 | 40.80 | 0.5656 | 5.1 | 8.60 |
| 11 | −9.6061 | 0.510 | 1.80518 | 25.46 | 0.6157 | 0.9 | 9.33 |
| 12 | 23.0346 | 4.072 | | | | | 10.04 |
| 13 | −7.7366 | 0.500 | 1.60342 | 38.01 | 0.5828 | 2.7 | 11.25 |
| 14 | −31.9726 | 0.150 | | | | | 14.28 |
| *15 | 71.0795 | 4.699 | 1.85135 | 40.10 | 0.5695 | 7.6 | 18.98 |
| *16 | −17.6735 | DD[16] | | | | | 19.83 |

TABLE 26
Example 9

| | Infinite | Short range |
|---|---|---|
| | distance | −0.16× |
| focal length | 22.34 | 22.34 |
| back focus | 11.098 | 14.672 |
| FNo. | 2.88 | 3.21 |
| 2ω[°] | 69.0 | 63.2 |
| DD[16] | 11.098 | 14.672 |

TABLE 27
Example 9

| Sn | 1 | 3 | 15 | 16 |
|---|---|---|---|---|
| KA | 1.0000000E+00 | 1.0000000E+00 | 1.0000000E+00 | 1.0000000E+00 |
| A3 | 2.5287514E−19 | −2.5287514E−19 | −1.9549851E−19 | −9.7749257E−20 |
| A4 | −1.2627021E−04 | −2.1597937E−04 | −1.2123968E−04 | 6.9090715E−05 |
| A5 | −1.2194933E−04 | −4.0728108E−05 | 3.7298665E−05 | −9.9780595E−06 |
| A6 | 3.7610621E−05 | −9.5669778E−06 | −2.9772796E−06 | 1.7295259E−06 |
| A7 | −1.5171669E−06 | 7.5681853E−06 | −1.6431307E−07 | 2.1704894E−07 |
| A8 | −1.1888916E−06 | −6.7603890E−07 | 4.8554230E−08 | −4.1853836E−08 |
| A9 | 9.0793742E−08 | −1.6594859E−07 | −1.7729485E−09 | −3.6543315E−10 |
| A10 | 2.2935182E−08 | 1.2864468E−08 | −1.5771355E−10 | 3.4805169E−10 |
| A11 | −1.1303003E−09 | 1.3970224E−09 | 1.2697769E−11 | −3.9280168E−12 |
| A12 | −2.5218829E−10 | 8.0788877E−11 | −2.7396094E−13 | −8.9548971E−13 |

Table 28 and Table 29 show the corresponding values of Conditional Expressions (1) to (22) of the imaging lenses according to Examples 1 to 9. In the rows of Conditional Expression (1) of Table 28 and Table 29, only the lenses with a concave surface facing the object side in the second lens group G2 are shown. The corresponding values of Examples of Tables 28 and 29 may be used as the upper limit value or the lower limit value of the conditional expression to set a preferable range of the conditional expression.

TABLE 28

| Expression | | | | | | |
|---|---|---|---|---|---|---|
| number | | Example 1 | Example 2 | Example 3 | Example 4 | Example 5 |
| (1) | f/Rf | −1.3152 | −1.6601 | −1.2869 | −1.2359 | −1.5016 |
| | | −0.6286 | −3.6583 | −0.8526 | −0.4746 | −0.1181 |
| | | −2.4118 | | −3.1934 | −3.3405 | −2.8821 |
| (2) | f/f1 | 0.5997 | 0.5690 | 0.4115 | 0.5181 | 0.4027 |
| (3) | f/f2 | 0.5671 | 0.6536 | 0.7659 | 0.7023 | 0.7471 |
| (4) | f2/f1 | 1.0575 | 0.8705 | 0.5373 | 0.7377 | 0.5390 |
| (5) | (R1r − R1f)/(R1r + R1f) | −5.0630 | −1.6185 | −1.1088 | 7.8545 | −1.7839 |
| (6) | f/R1f | −1.0352 | −0.3046 | −0.0715 | −0.9815 | −0.3321 |
| (7) | f/fL1p | 1.9625 | 1.4191 | 1.1446 | 1.3830 | 1.2950 |
| (8) | f/fL1n | −1.5645 | −0.8636 | −0.7528 | −0.9018 | −0.9139 |
| (9) | (RAr − RAf)/(RAr + RAf) | −7.5332 | −2.9529 | −3.1280 | −2.6831 | −4.2029 |
| (10) | d12/L1th | 1.1494 | 0.2997 | 0.6365 | 0.4000 | 0.2997 |
| (11) | f/fLe | 1.2219 | 1.4242 | 1.3807 | 1.4056 | 1.3506 |
| (12) | NdLe | 1.85135 | 1.85135 | 1.85135 | 1.80610 | 1.85135 |
| (13) | ddLe/f | 0.0063 | 0.0065 | 0.0067 | 0.0066 | 0.0063 |
| (14) | Bf/TL | 0.2701 | 0.3180 | 0.3091 | 0.3111 | 0.2933 |
| (15) | TL/f | 1.7306 | 1.5165 | 1.6065 | 1.5730 | 1.5948 |
| (16) | (RSr − RSf)/(RSr + RSf) | −0.1660 | −0.9357 | −0.7207 | −0.5378 | −0.7129 |
| (17) | Dexp/f | −1.5068 | −1.3911 | −1.5689 | −1.4988 | −1.4372 |
| (18) | φap/φend | 0.6109 | 0.3946 | 0.4025 | 0.4023 | 0.4802 |
| (19) | Nd1 | 1.60342 | 1.54072 | 1.51633 | 1.51625 | 1.60342 |
| (20) | Nd1r | 1.85135 | 1.85135 | 1.85033 | 1.77250 | 1.85135 |
| (21) | vd1 − vd1r | −2.09 | 7.10 | 21.36 | 14.45 | −2.09 |
| (22) | dNp/dT | −6.1 | 4.1 | 4.1 | 3.9 | −2.9 |

TABLE 29

| Expression | | | | | |
|---|---|---|---|---|---|
| number | | Example 6 | Example 7 | Example 8 | Example 9 |
| (1) | f/Rf | −1.8260 | −2.0265 | −1.3173 | −3.0732 |
| | | −1.3005 | −1.6402 | −1.2999 | −2.3246 |
| | | −3.2132 | −3.2158 | −3.1309 | −2.8863 |
| (2) | f/f1 | 0.7092 | 0.7164 | 0.5829 | 0.7015 |
| (3) | f/f2 | 0.5415 | 0.5191 | 0.7320 | 0.5864 |
| (4) | f2/f1 | 1.3097 | 1.3801 | 0.7962 | 1.1962 |
| (5) | (R1r − R1f)/(R1r + R1f) | −1.9046 | −1.6349 | −1.0357 | −1.1318 |
| (6) | f/R1f | −0.4007 | −0.3605 | −0.0536 | −0.0536 |
| (7) | f/fL1p | 1.7309 | 1.8840 | 3.0164 | 0.7540 |
| (8) | f/fL1n | −1.0487 | −1.2053 | −1.9075 | −0.6351 |
| (9) | (RAr − RAf)/(RAr + RAf) | −3.2310 | −2.9814 | −2.3789 | −2.0115 |
| (10) | d12/L1th | 0.3000 | 0.3002 | 0.0000 | 0.0000 |
| (11) | f/fLe | 1.4891 | 1.4292 | 1.5353 | 1.3104 |
| (12) | NdLe | 1.85135 | 1.85135 | 1.85135 | 1.85135 |
| (13) | ddLe/f | 0.0064 | 0.0063 | 0.0067 | 0.0067 |
| (14) | Bf/TL | 0.3183 | 0.3183 | 0.3175 | 0.3097 |
| (15) | TL/f | 1.4769 | 1.4698 | 1.5638 | 1.6050 |
| (16) | (RSr − RSf)/(RSr + RSf) | −0.8185 | −0.7604 | −7.4064 | −1.0445 |
| (17) | Dexp/f | −1.3839 | −1.3554 | −1.4333 | −1.4601 |
| (18) | pap/pend | 0.4060 | 0.4077 | 0.3389 | 0.3672 |
| (19) | Nd1 | 1.62004 | 1.64769 | 1.61340 | 1.68948 |
| (20) | Nd1r | 1.85135 | 1.85135 | 1.85135 | 1.78590 |
| (21) | vd1 − vd1r | −3.80 | −6.26 | 4.17 | −12.91 |
| (22) | dNp/dT | 4.1 | 3.4 | 4.2 | 4.8 |

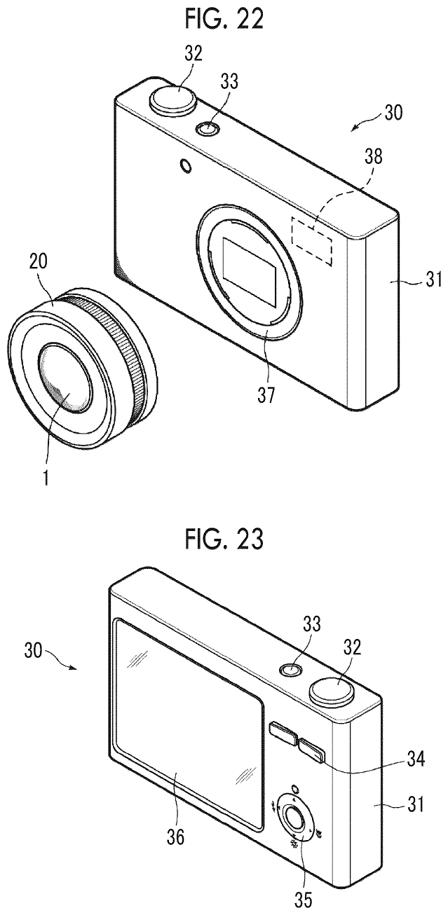

Hereinafter, an imaging apparatus according to the embodiment of the present disclosure will be described. FIGS. 22 and 23 show external views of a camera 30 that is the imaging apparatus according to the embodiment of the present disclosure. FIG. 22 shows a perspective view of the camera 30 viewed from the front surface side, and FIG. 23 shows a perspective view of the camera 30 viewed from the rear surface side. The camera 30 is a so-called mirrorless type digital camera in which an interchangeable lens 20 can be attachably and detachably mounted. The interchangeable lens 20 includes an imaging lens 1 according to the embodiment of the present disclosure accommodated in a lens barrel.

The camera 30 comprises a camera body 31. An upper surface of the camera body 31 is provided with a shutter button 32 and a power button 33. A rear surface of the camera body 31 is provided with an operation unit 34, an operation unit 35, and a display unit 36. The display unit 36 can display the captured image and an image within an angle of view before capturing.

An imaging aperture on which light from an imaging target is incident is provided at a center portion of a front surface of the camera body 31. A mount 37 is provided at a position corresponding to the imaging aperture, and the interchangeable lens 20 is mounted in the camera body 31 via the mount 37.

An imaging element 38 is provided inside the camera body 31. The imaging element 38 outputs an imaging signal corresponding to the subject image formed by the interchangeable lens 20. As the imaging element 38, for example, a charge-coupled device (CCD) or a complementary-metal-oxide semiconductor (CMOS) is used. A signal processing circuit (not shown), a recording medium (not shown), and the like are provided inside the camera body 31. The signal processing circuit generates the image by processing the imaging signal output from the imaging element 38. The recording medium is used for recording the generated image. In the camera 30, a still image or a moving image can be captured by pressing the shutter button 32, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and may take various forms, for example a type of camera other than a mirrorless camera, a film camera, a video camera, and a security camera.

The following supplementary notes are further disclosed with respect to the embodiment and the examples described above.

### Supplementary Note 1

An imaging lens consisting of, in order from an object side toward an image side, a first lens group, a stop, and a second lens group, in which the second lens group includes two or more lenses that satisfy Conditional Expression (1) represented by −15<f/Rf<−0.5 (1), where a focal length of the imaging lens in a state in which an infinite distance object is in focus is denoted by f, and a curvature radius of an object-side surface of a lens included in the imaging lens is denoted by Rf.

### Supplementary Note 2

The imaging lens according to supplementary note 1, in which in a case in which a focal length of the first lens group is denoted by f1, Conditional Expression (2) represented by 0.1<f/f1<0.9 (2) is satisfied.

### Supplementary Note 3

The imaging lens according to supplementary note 1 or 2, in which in a case in which a focal length of the second lens group is denoted by f2, Conditional Expression (3) represented by 0.1<f/f2<0.9 (3) is satisfied.

### Supplementary Note 4

The imaging lens according to any one of supplementary notes 1 to 3, in which in a case in which a focal length of the first lens group is denoted by f1, and a focal length of the second lens group is denoted by f2, Conditional Expression (4) represented by 0.2<f2/f1<3 (4) is satisfied.

### Supplementary Note 5

The imaging lens according to any one of supplementary notes 1 to 4, in which in a case in which a curvature radius of an object-side surface of an extreme object-side lens of the first lens group is denoted by R1f, and a curvature radius of an image-side surface of an extreme object-side lens of the first lens group is denoted by R1r, Conditional Expression (5) represented by −10<(R1r−R1f)/(R1r+R1f)<10 (5) is satisfied.

### Supplementary Note 6

The imaging lens according to any one of supplementary notes 1 to 5, in which in a case in which a curvature radius of an object-side surface of an extreme object-side lens of the first lens group is denoted by R1f, Conditional Expression (6) represented by −5<f/R1f<0 (6) is satisfied.

### Supplementary Note 7

The imaging lens according to any one of supplementary notes 1 to 6, in which in a case in which a focal length of a lens having strongest positive refractive power among lenses included in the first lens group is denoted by fL1p, Conditional Expression (7) represented by 0.2<f/fL1p<5 (7) is satisfied.

### Supplementary Note 8

The imaging lens according to any one of supplementary notes 1 to 7, in which in a case in which a focal length of a lens having strongest negative refractive power among lenses included in the first lens group is denoted by fL1n, Conditional Expression (8) represented by −4<f/fL1n<−0.2 (8) is satisfied.

### Supplementary Note 9

The imaging lens according to any one of supplementary notes 1 to 8, in which the second lens group includes an air lens formed by two concave lens surfaces facing each other, and in a case in which a paraxial curvature radius of an object-side surface of the air lens of the second lens group is denoted by RAf, and a paraxial curvature radius of an image-side surface of the air lens of the second lens group is denoted by RAr, Conditional Expression (9) represented by −10<(RAr−RAf)/(RAr+RAf)<0 (9) is satisfied.

### Supplementary Note 10

The imaging lens according to any one of supplementary notes 1 to 9, in which the first lens group includes, successively in order from an extreme object side toward the image side, a first lens having a biconcave shape and a second lens having positive refractive power with a convex surface facing the object side, and in a case in which a spacing on an optical axis between the first lens and the second lens is denoted by d12, and a central thickness of the first lens is denoted by L1th, Conditional Expression (10) represented by 0≤d12/L1th<3 (10) is satisfied.

### Supplementary Note 11

The imaging lens according to any one of supplementary notes 1 to 10, in which the second lens group includes, on an extreme image side, an extreme image-side lens having positive refractive power with a convex surface facing the image side, and in a case in which a focal length of the extreme image-side lens is denoted by fLe, Conditional Expression (11) represented by 0.2<f/fLe<5 (11) is satisfied.

### Supplementary Note 12

The imaging lens according to supplementary note 11, in which in a case in which a refractive index of the extreme image-side lens at a d line is denoted by NdLe, Conditional Expression (12) represented by 1.6<NdLe<2.4 (12) is satisfied.

### Supplementary Note 13

The imaging lens according to supplementary note 11 or 12, in which a negative meniscus lens with a convex surface facing the image side is disposed adjacent to the object side of the extreme image-side lens, and in a case in which a spacing on an optical axis between the negative meniscus lens disposed adjacent to the object side of the extreme image-side lens and the extreme image-side lens is denoted by ddLe, Conditional Expression (13) represented by 0≤ddLe/f<0.16 (13) is satisfied.

### Supplementary Note 14

The imaging lens according to any one of supplementary notes 11 to 13, in which an image-side lens surface of the extreme image-side lens is an aspherical surface including a region in which positive refractive power is decreased as a distance from the optical axis is increased.

### Supplementary Note 15

The imaging lens according to any one of supplementary notes 1 to 14, in which in a case in which a back focus of the imaging lens in terms of an air-equivalent distance in a state in which the infinite distance object is in focus is denoted by Bf, and a sum of a distance on an optical axis from an extreme object-side surface of the first lens group to an extreme image-side surface of the second lens group and the back focus of the imaging lens in terms of the air-equivalent distance in a state in which the infinite distance object is in focus is denoted by TL, Conditional Expression (14) represented by 0.1<Bf/TL<0.5 (14) is satisfied.

### Supplementary Note 16

The imaging lens according to any one of supplementary notes 1 to 15, in which in a case in which a sum of a distance on an optical axis from an extreme object-side surface of the first lens group to an extreme image-side surface of the second lens group and a back focus of the imaging lens in terms of an air-equivalent distance in a state in which the infinite distance object is in focus is TL, Conditional Expression (15) represented by 1.2<TL/f<3 (15) is satisfied.

### Supplementary Note 17

The imaging lens according to any one of supplementary notes 1 to 16, in which in a case in which a curvature radius of a lens surface adjacent to the object side of the stop is denoted by RSf, and a curvature radius of a lens surface adjacent to the image side of the stop is denoted by RSr, Conditional Expression (16) represented by −10<(RSr-RSf)/(RSr+RSf)<0 (16) is satisfied.

### Supplementary Note 18

The imaging lens according to any one of supplementary notes 1 to 17, in which in a case in which a distance on an optical axis from an image plane to a paraxial exit pupil position in a state in which the infinite distance object is in focus is denoted by Dexp, and a sign of Dexp is defined such that, with the image plane as a reference, a distance toward the object side is negative and a distance toward the image side is positive, Conditional Expression (17) represented by −3<Dexp/f<−0.7 (17) is satisfied.

### Supplementary Note 19

The imaging lens according to any one of supplementary notes 1 to 18, in which in a case in which an aperture diameter of the stop in an open state is denoted by φap, and an effective diameter of an extreme image-side lens surface of the second lens group is denoted by φend, Conditional Expression (18) represented by 0.3<φap/φend<0.65 (18) is satisfied.

### Supplementary Note 20

An imaging apparatus comprising: the imaging lens according to any one of supplementary notes 1 to 19.

What is claimed is:

1. An imaging lens consisting of, in order from an object side toward an image side, a first lens group, a stop, and a second lens group,
wherein the second lens group includes two or more lenses that satisfy Conditional Expression (1) represented by
$$- 15 < f / Rf < - 0.5 , \qquad ( 1 )$$
where
a focal length of the imaging lens in a state in which an infinite distance object is in focus is denoted by f, and
a curvature radius of an object-side surface of a lens included in the imaging lens is denoted by Rf.

2. The imaging lens according to claim 1,
wherein in a case in which a focal length of the first lens group is denoted by f1,
Conditional Expression (2) represented by
$$0.1 < f / f 1 < 0.9 \qquad ( 2 )$$
is satisfied.

3. The imaging lens according to claim 1,
wherein in a case in which a focal length of the second lens group is denoted by f2,
Conditional Expression (3) represented by
$$0.1 < f / f 2 < 0.9 \qquad ( 3 )$$
is satisfied.

4. The imaging lens according to claim 1,
wherein in a case in which
a focal length of the first lens group is denoted by f1, and
a focal length of the second lens group is denoted by f2,
Conditional Expression (4) represented by
$$0.2 < f 2 / f 1 < 3 \qquad ( 4 )$$
is satisfied.

5. The imaging lens according to claim 1,
wherein in a case in which
a curvature radius of an object-side surface of an extreme object-side lens of the first lens group is denoted by R1f, and
a curvature radius of an image-side surface of an extreme object-side lens of the first lens group is denoted by R1r,
Conditional Expression (5) represented by
$$- 10 < ( R 1 r - R 1 f ) / ( R 1 r + R 1 f ) < 10 \qquad ( 5 )$$
is satisfied.

6. The imaging lens according to claim 1,
wherein in a case in which a curvature radius of an object-side surface of an extreme object-side lens of the first lens group is denoted by R1f,
Conditional Expression (6) represented by
$$- 5 < f / R 1 f < 0 \qquad ( 6 )$$
is satisfied.

7. The imaging lens according to claim 1,
wherein in a case in which a focal length of a lens having strongest positive refractive power among lenses included in the first lens group is denoted by fL1p,
Conditional Expression (7) represented by
$$0.2 < f / fL 1 p < 5 \qquad ( 7 )$$
is satisfied.

8. The imaging lens according to claim 1,
wherein in a case in which a focal length of a lens having strongest negative refractive power among lenses included in the first lens group is denoted by fL In,
Conditional Expression (8) represented by
$$- 4 < f / fL 1 n < - 0.2 \qquad ( 8 )$$
is satisfied.

9. The imaging lens according to claim 1,
wherein the second lens group includes an air lens formed by two concave lens surfaces facing each other, and
in a case in which
a paraxial curvature radius of an object-side surface of the air lens of the second lens group is denoted by RAf, and
a paraxial curvature radius of an image-side surface of the air lens of the second lens group is denoted by RAr,
Conditional Expression (9) represented by
$$- 10 < ( RAr - RAf ) / ( RAr + RAf ) < 0 \qquad ( 9 )$$
is satisfied.

10. The imaging lens according to claim 1,
wherein the first lens group includes, successively in order from an extreme object side toward the image side, a first lens having a biconcave shape and a second lens having positive refractive power with a convex surface facing the object side, and
in a case in which
a spacing on an optical axis between the first lens and the second lens is denoted by d12, and
a central thickness of the first lens is denoted by L1th,
Conditional Expression (10) represented by
$$0 \leq d 12 / L 1 th < 3 \qquad ( 10 )$$
is satisfied.

11. The imaging lens according to claim 1,
wherein the second lens group includes, on an extreme image side, an extreme image-side lens having positive refractive power with a convex surface facing the image side, and
in a case in which a focal length of the extreme image-side lens is denoted by fLe,
Conditional Expression (11) represented by
$$0.2 < f / fLe < 5 \qquad ( 11 )$$
is satisfied.

12. The imaging lens according to claim 11,
wherein in a case in which a refractive index of the extreme image-side lens at a d line is denoted by NdLe,
Conditional Expression (12) represented by
$$1.6 < NdLe < 2.4 \qquad ( 12 )$$
is satisfied.

13. The imaging lens according to claim 11,
wherein a negative meniscus lens with a convex surface facing the image side is disposed adjacent to the object side of the extreme image-side lens, and
in a case in which a spacing on an optical axis between the negative meniscus lens disposed adjacent to the object side of the extreme image-side lens and the extreme image-side lens is denoted by ddLe,
Conditional Expression (13) represented by
$$0 \leq ddLe / f < 0.16 \qquad ( 13 )$$
is satisfied.

14. The imaging lens according to claim 11,
wherein an image-side lens surface of the extreme image-side lens is an aspherical surface including a region in which positive refractive power is decreased as a distance from the optical axis is increased.

15. The imaging lens according to claim 1,
wherein in a case in which
a back focus of the imaging lens in terms of an air-equivalent distance in a state in which the infinite distance object is in focus is denoted by Bf, and
a sum of a distance on an optical axis from an extreme object-side surface of the first lens group to an extreme image-side surface of the second lens group and the back focus of the imaging lens in terms of the air-equivalent distance in a state in which the infinite distance object is in focus is denoted by TL,
Conditional Expression (14) represented by
$$0.1 < Bf / TL < 0.5 \qquad ( 14 )$$
is satisfied.

16. The imaging lens according to claim 1,
wherein in a case in which a sum of a distance on an optical axis from an extreme object-side surface of the first lens group to an extreme image-side surface of the second lens group and a back focus of the imaging lens in terms of an air-equivalent distance in a state in which the infinite distance object is in focus is TL,
Conditional Expression (15) represented by
$$1.2 < TL / f < 3 \qquad ( 15 )$$
is satisfied.

17. The imaging lens according to claim 1,
wherein in a case in which
a curvature radius of a lens surface adjacent to the object side of the stop is denoted by RSf, and
a curvature radius of a lens surface adjacent to the image side of the stop is denoted by RSr,
Conditional Expression (16) represented by
$$- 10 < ( RSr - RSf ) / ( RSr + RSf ) < 0 \qquad ( 16 )$$
is satisfied.

18. The imaging lens according to claim 1,
wherein in a case in which
a distance on an optical axis from an image plane to a paraxial exit pupil position in a state in which the infinite distance object is in focus is denoted by Dexp, and
a sign of Dexp is defined such that, with the image plane as a reference, a distance toward the object side is negative and a distance toward the image side is positive,
Conditional Expression (17) represented by
$$- 3 < D exp / f < - 0.7 \qquad ( 17 )$$
is satisfied.

19. The imaging lens according to claim 1,
wherein in a case in which
an aperture diameter of the stop in an open state is denoted by φap, and
an effective diameter of an extreme image-side lens surface of the second lens group is denoted by φend,
Conditional Expression (18) represented by
$$0.3 < φ ap / φend < 0.65 \qquad ( 18 )$$
is satisfied.

20. An imaging apparatus comprising:
the imaging lens according to claim 1.
